(19) United States
(12) Patent Application Publication
(10) Pub. No.: US 2007/0283072 A1
(43) Pub. Date: Dec. 6, 2007

(54) Method And Apparatus For Generating Configuration Data

(76) Inventor: Paul Thomas Johnson, Cambridge (GB)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 10/590,583

(22) PCT Filed: Feb. 25, 2005
(86) PCT No.: PCT/GB05/00711

§ 371 Date: Jun. 5, 2007

(30) Foreign Application Priority Data
Feb. 27, 2004 (GB) 0404443.4

(51) Int. Cl. G06F 13/14

(52) U.S. Cl. 710/305

(57) ABSTRACT

A computer system (1) is described for programming and testing microcontrollers (8). The computer System (1) includes an interactive design environment (20) comprising a configuration module (22), an assembler (24), a compiler (26) and a debugger (28). The compiler (26), assembler (24) and debugger (28) all enable high level program data (30) to be converted into binary code and stored within a program store to control the functioning of a CPU included within a micro-controller (8). The configuration module (22) is such to enable a user to generate a configuration program (30) for storing values in registers for controlling the settings of inbuilt peripherals in the micro-controller (8) and the routing of signals to and from the peripherals. The register values for routing signals are identified in a two stage process. Firstly utilising the configuration module (22) a user identifies which peripherals are to be enabled. A user interface is then generated to illustrate possible configurations for routing the signals necessary for the identified set of peripherals. A user can then select which of the identified sets of configuration data should be used to generate a configuration program (20).

The present application relates method and apparatus for generating configuration data. In particular, the present application concerns the generation of configuration data for configuring micro-controllers.

Many apparatus require embedded microprocessor systems or micro-controllers to control the processing of the apparatus. Such micro-controllers comprise a microchip having a number of pins to enable signals to enter and exit the microchip. The microchip will typically include a central processing unit, a memory and a number of inbuilt peripherals for undertaking specific tasks within the micro-controller.

In modern micro-controller design, often the number of signals that the inbuilt peripherals can receive, interact with and output exceeds the number of pins available on the microchip. This is because usually only a subset of the available peripherals needs to be utilised in any particular application. In such circumstance, the programming of a micro-controller has two parts. Firstly, a computer program for controlling the processing of the CPU of the micro-controller needs to be written and stored in the memory of the micro-controller. Conventionally, this is achieved by writing software in a high level programming language and compiling the generated code into binary code which is stored within the memory of the micro-controller.

The second aspect of programming a micro-controller comprises determining appropriate settings for the peripherals available within a micro-controller so that the peripherals which are utilised can interact and output signals via the available pins on the micro-controller. This second aspect of programming a micro-controller is difficult as incompatible settings can give rise to incorrect operation which is difficult to identify and correct. There is therefore a need for systems which enable this second aspect of programming micro-controllers more easily undertaken.

In accordance with one aspect of the present invention there is provided a micro-controller configuration apparatus operable to identify a set of register values for storage within registers of a micro-controller including a plurality of peripherals, the micro-controller being operable to route different selections of signals to and from said peripherals on the basis of the register values stored in said registers, said configuration apparatus comprising:
a first user input interface generator operable to generate a first user interface to enable a user to input data identifying a selection of peripherals from the plurality of peripherals included in said micro-controller;
a determination module operable to determine for data identifying a selection of peripherals, input via said first user interface, a set of signals required for routing to and from said selected peripherals to enable each of said peripherals to function, said determination module further being operable to identify a plurality of combinations of register values which when stored within registers of a micro-controller enable all of the determined signals to be routed to and from said selected peripherals; a second user input interface generator operable to generate a second user interface to enable a user to select one of said plurality of combinations of register values identified by said determination module; and
an output module operable to output data identifying a set of register values for storage within registers in a micro-controller including register values corresponding to a combination of register values selected via said second user interface.

Further aspects and embodiments of the present invention will become apparent with reference to the accompanying drawings in which:

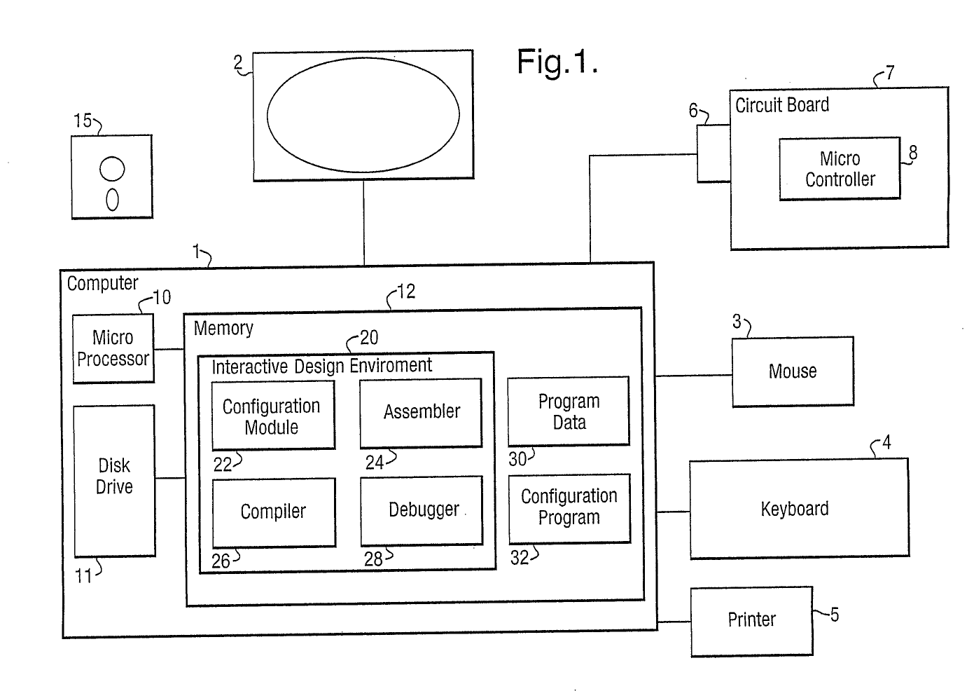

FIG. 1 is a schematic block diagram of a computer system for in-line testing of a micro-controller including a configuration module for generating configuration data in accordance with a first embodiment of the present invention;

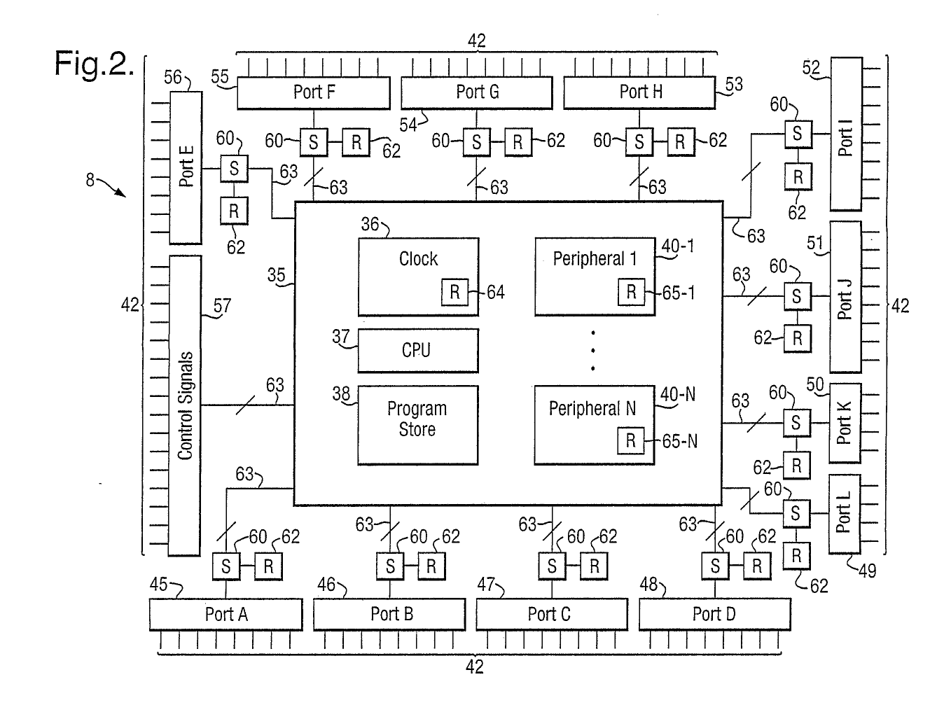

FIG. 2 is a schematic block diagram of an exemplary micro-controller;

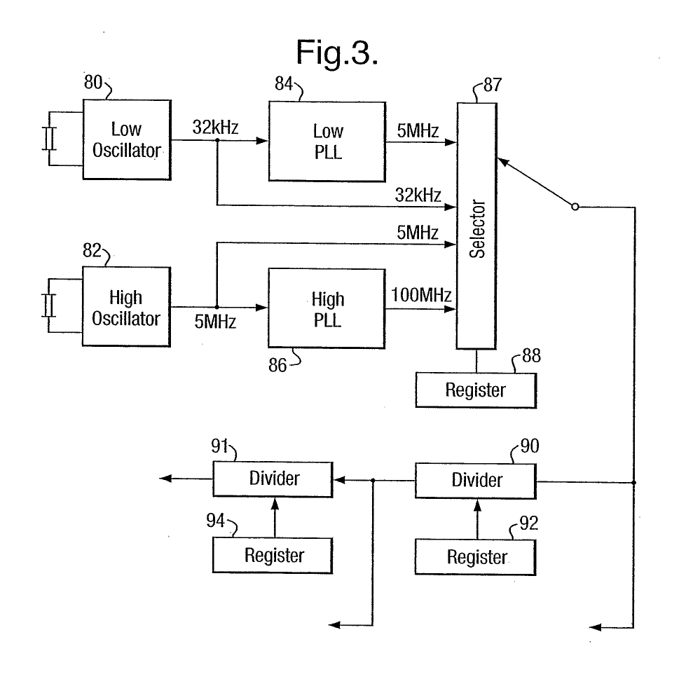

FIG. 3 is a schematic block diagram of the components of the clock module of the micro-controller of FIG. 2;

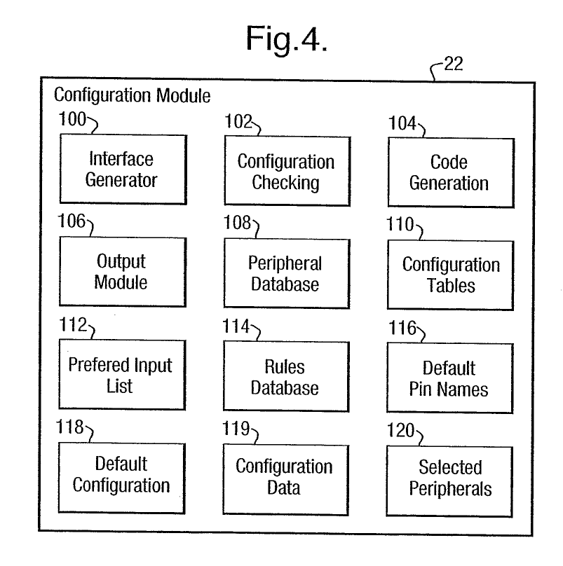

FIG. 4 is a schematic block diagram of the sub-modules of the configuration module of FIG. 1;

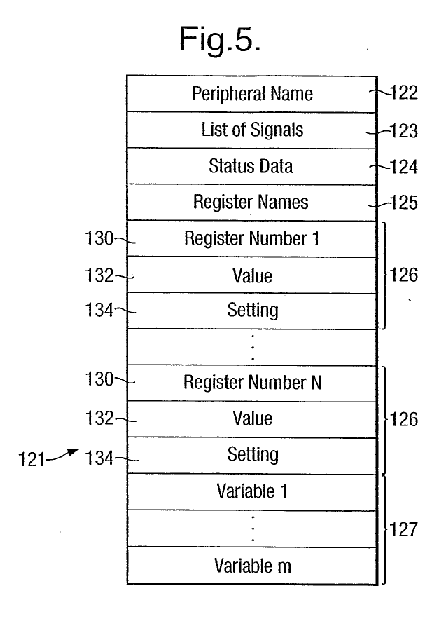

FIG. 5 is a schematic block diagram of a peripheral record within the peripheral database of the configuration module of FIG. 4;

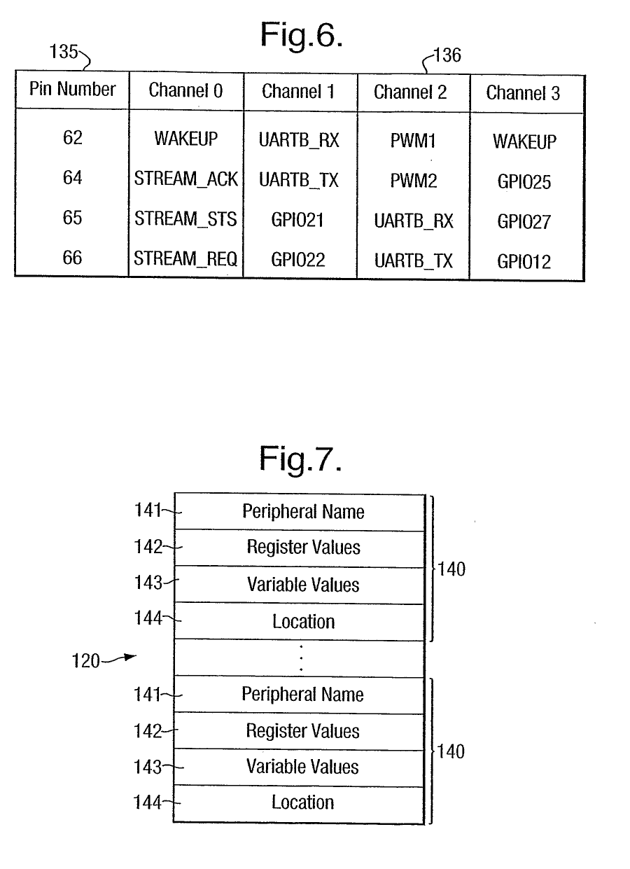

FIG. 6 is an illustration of a configuration table for identifying channel settings for a port of an exemplary micro-controller;

FIG. 7 is a schematic block diagram of selected peripheral records within the selected peripherals database of the configuration module of FIG. 4;

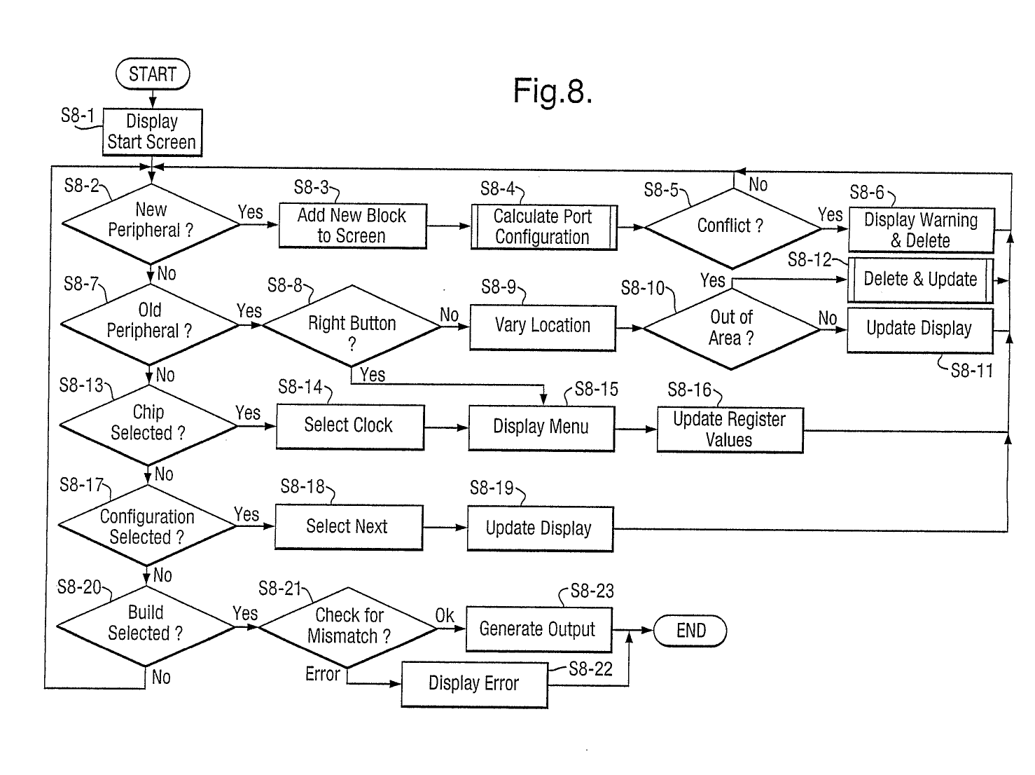

FIG. 8 is a flow diagram of the processing of the configuration module of FIG. 4;

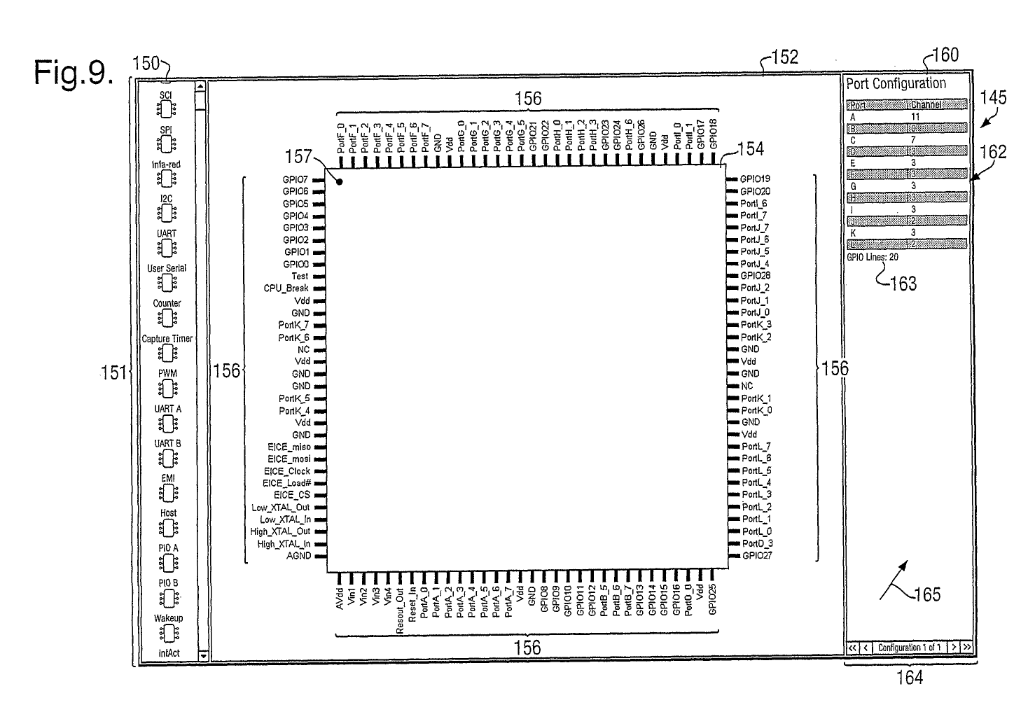

FIG. 9 is an exemplary illustration of a user interface generated by the configuration module of FIG. 4;

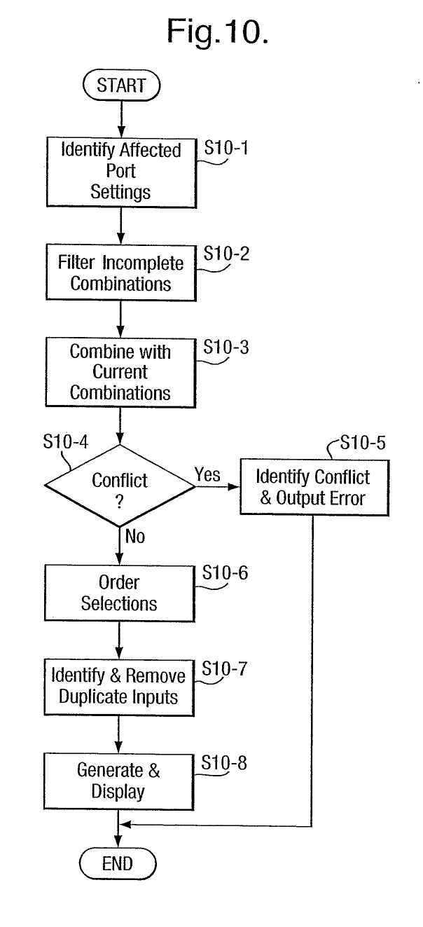

FIG. 10 is a flow diagram of the processing of the configuration checking module of the configuration module of FIG. 4 to determine compatible configuration settings for a selection of peripherals within a micro-controller;

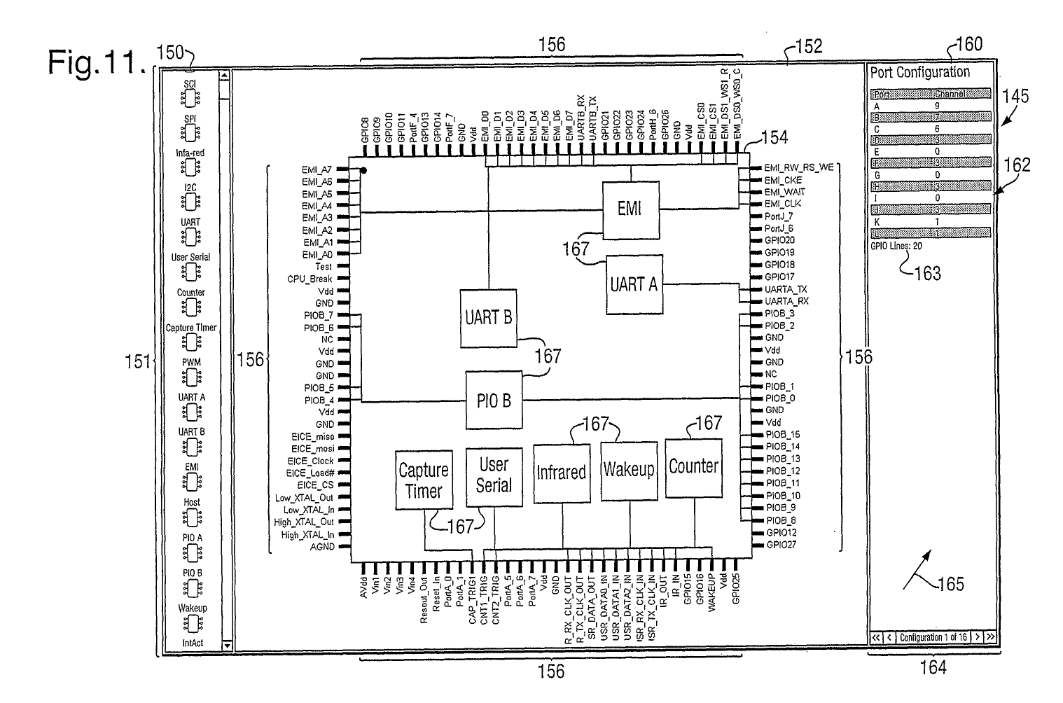

FIG. 11 is an exemplary illustration of a user interface after a number of peripherals available on a micro-controller have been selected for enablement;

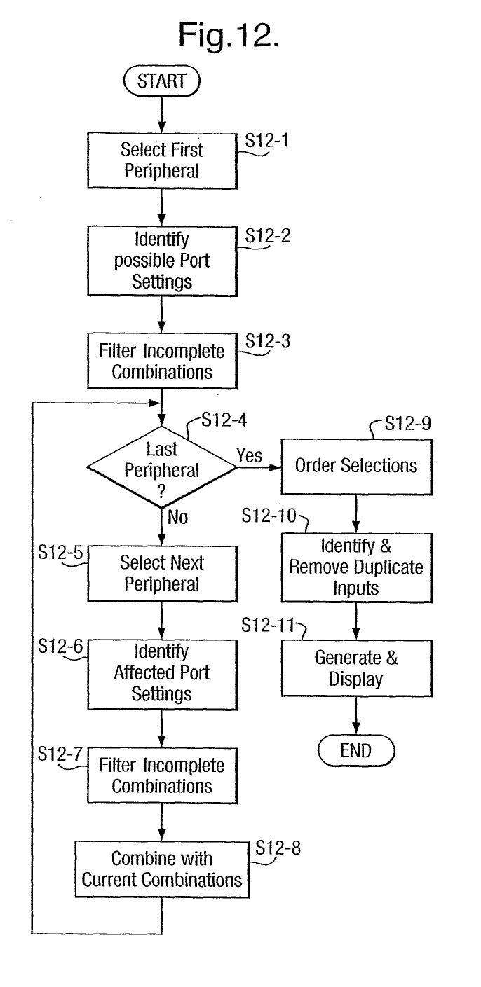

FIG. 12 is a flow diagram of the processing of the configuration checking module of the configuration module of FIG. 4 for calculating a set of possible compatible configuration settings for a selected set of peripherals;

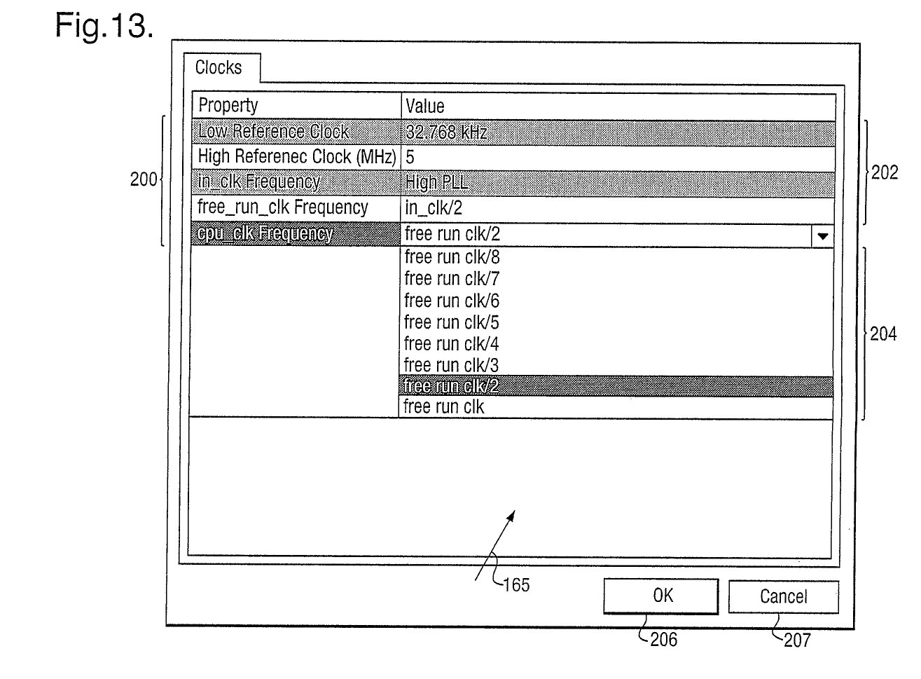

FIG. 13 is an exemplary illustration of a user interface menu for selecting settings for the clock module illustrated in FIG. 3;

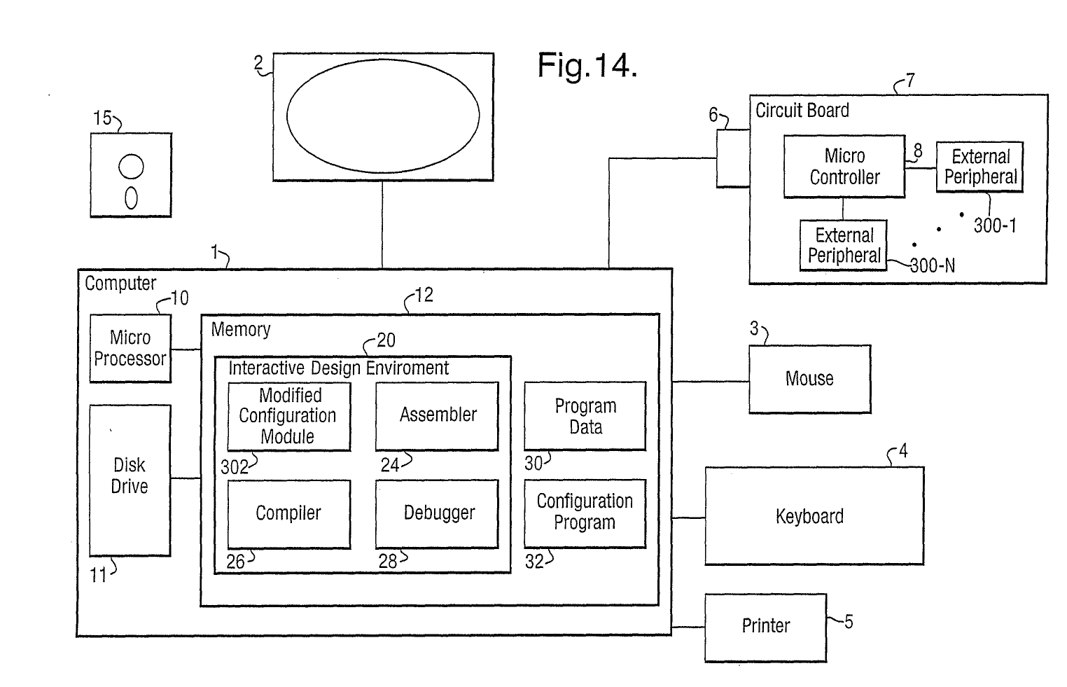

FIG. 14 is a schematic block diagram of a computer system for in-line testing a micro-controller including a modified configuration module for generating configuration data in accordance with a second embodiment of the present invention;

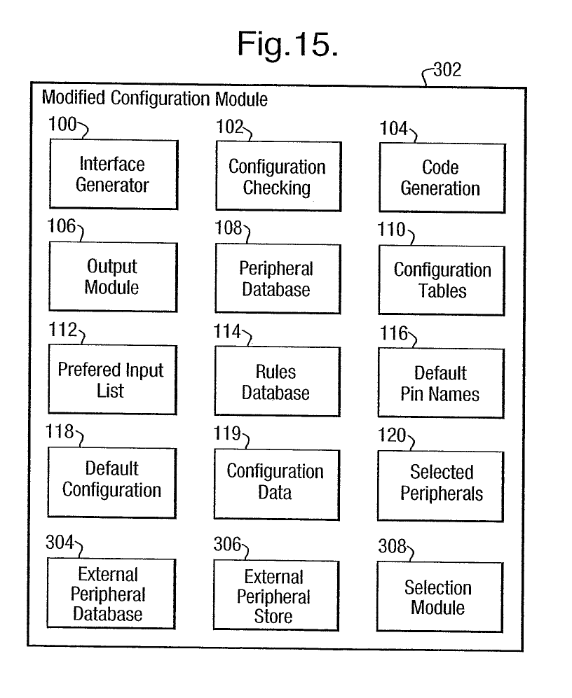

FIG. 15 is a schematic block diagram of the sub-modules of the modified configuration module of FIG. 14;

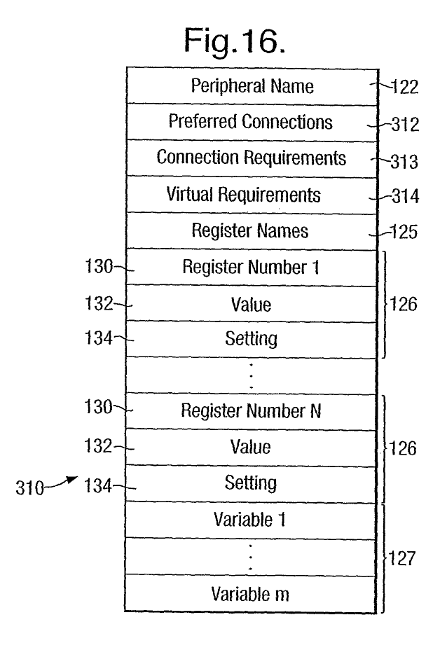

FIG. 16 is a schematic block diagram of an external peripheral record within the external peripheral database of the modified configuration module of FIG. 14;

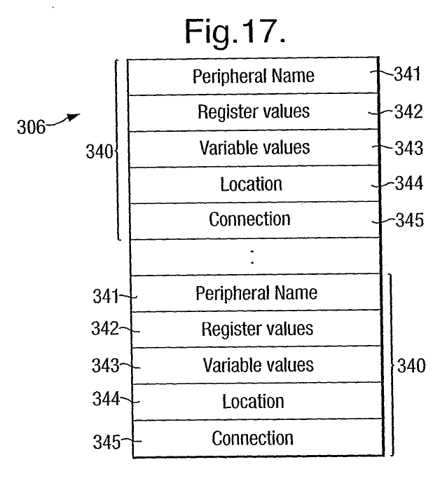

FIG. 17 is a schematic block diagram of selected external peripheral records within the external peripheral store of the modified configuration module of FIG. 14;

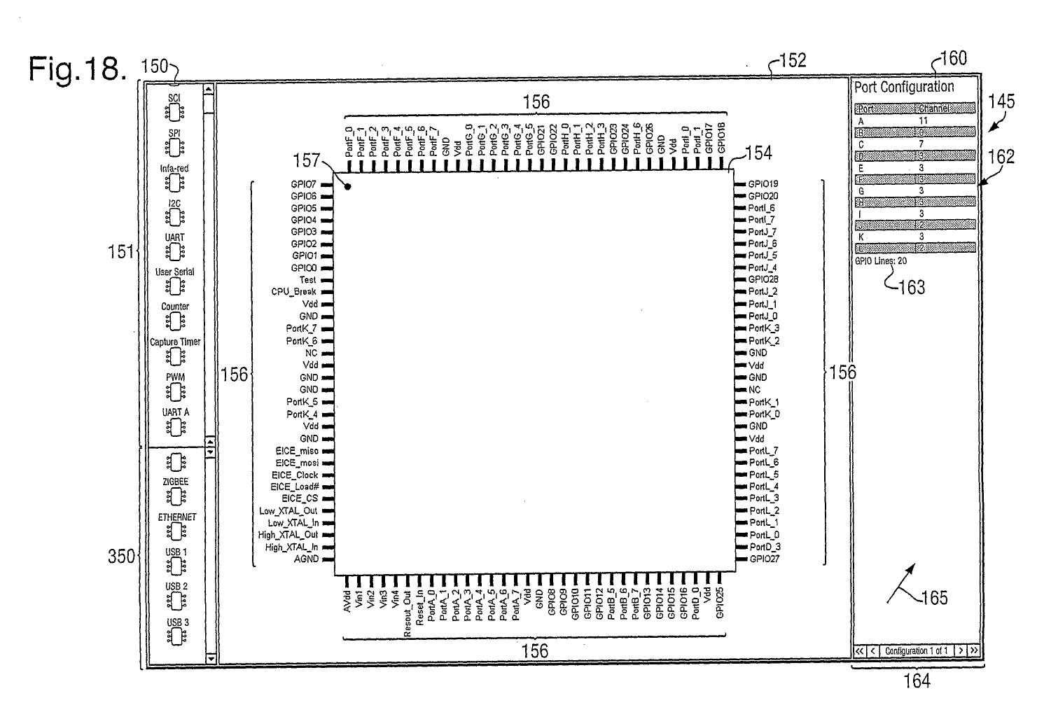

FIG. 18 is an exemplary illustration of a user interface generated by the modified configuration module of FIG. 14;

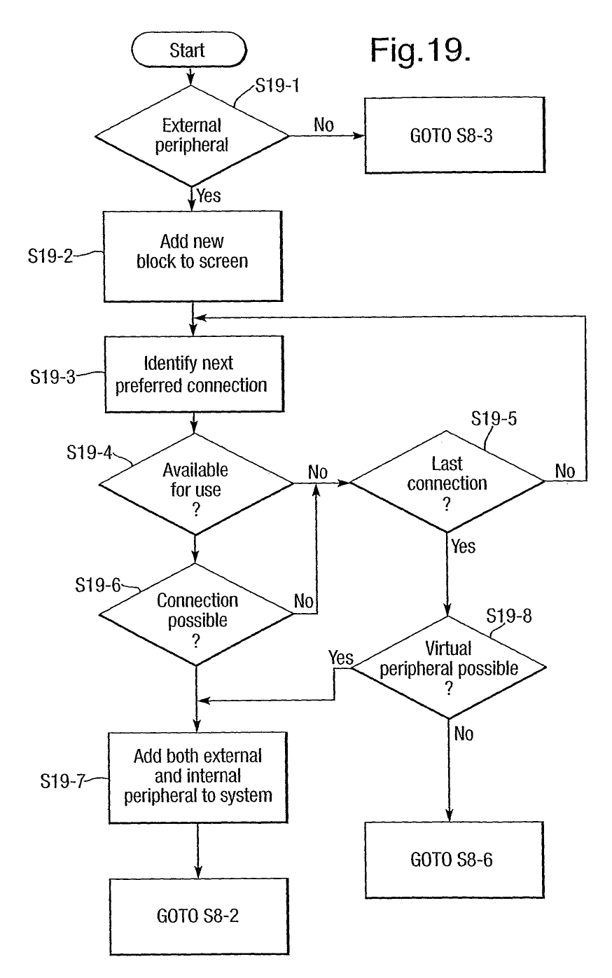

FIG. 19 is a flow diagram of the processing of the modified configuration module of FIG. 14; and

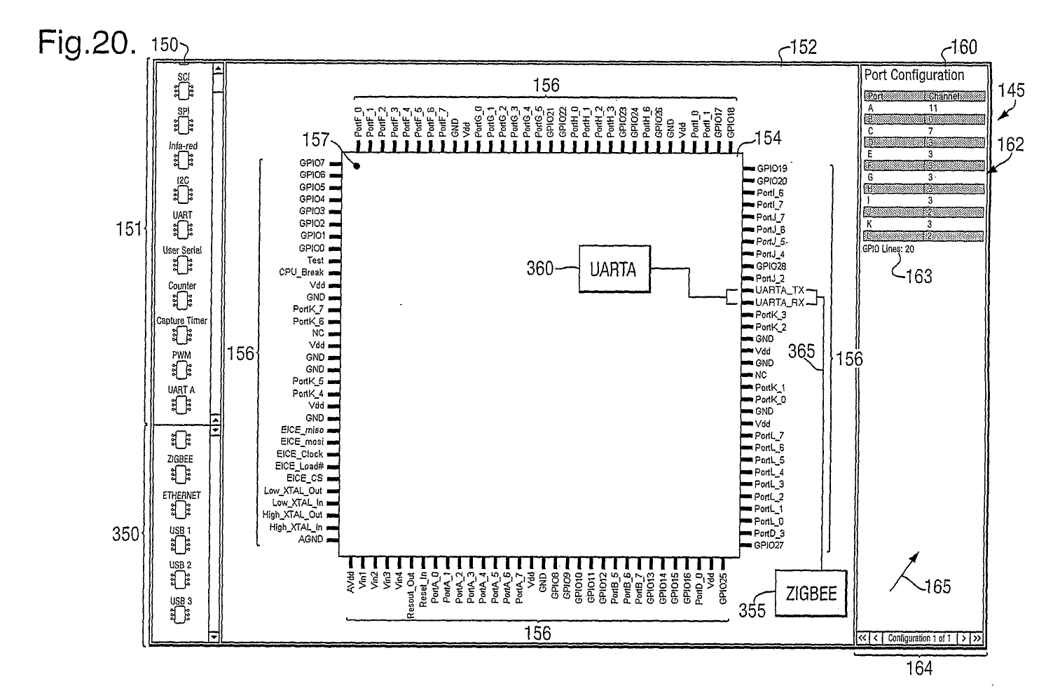

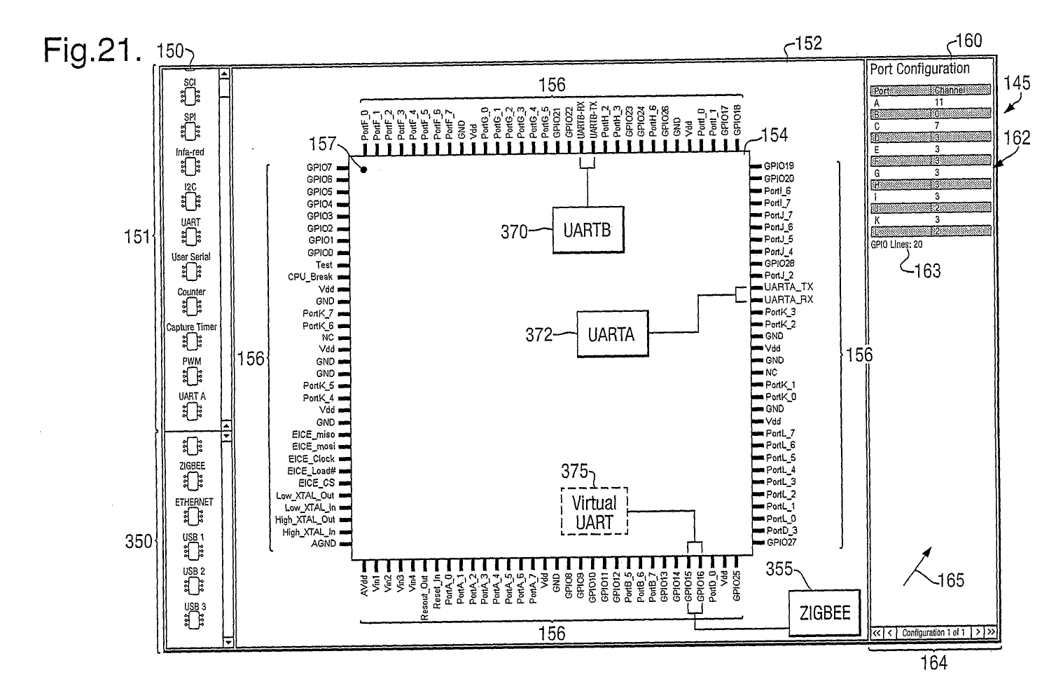

FIGS. 20 and 21 are further exemplary illustrations of user interfaces generated by the modified configuration module of FIG. 14.

### FIRST EMBODIMENT

FIG. 1 is an illustration of a computer system for performing in-line testing of a micro-controller in accordance with a first embodiment of the present invention. In particular, FIG. 1 is an illustration of a computer system including a computer 1 which is programmed to enable users to program and test micro-controllers more easily than is possible in the prior art.

As shown in FIG. 1, the computer 1 is connected to a display screen 2, a mouse 3, a keyboard 4 and a printer 5. The computer 1 is also connected via an interface 6 to a circuit board 7 on which there is provided a micro-controller 8. The computer 1 itself comprises a microprocessor 10, a disk drive 11 and a memory 12.

The disk drive is arranged to receive computer disks 15 which cause the memory 12 to be configured into functional modules defining an interactive design environment 20 comprising a configuration module 22, an assembler 24, a compiler 26 and a debugger 28.

In this embodiment, the assembler 24, compiler 26 and debugger 28 each comprise a conventional assembler, compiler and debugger which are arranged to process high level computer programs downloaded from disks 15 via the disk drive 11 and stored in the memory 12 as program data 30 and convert the high level computer program into binary code which is downloaded via the interface 6 into the memory of the micro-controller 8.

As will be described in detail later the configuration module 22 of the interactive design environment 20 is arranged to enable a user to input instructions via the keyboard 4 and mouse 3 to generate a configuration program 32 for the micro-controller 8. This configuration program 32 is such to configure the micro-controller 8 to enable a specific selection of peripherals on the micro-controller 8 to be enabled, and receive and output signals to specific pins connecting the micro-controller 8 to the circuit board 7. By providing this configuration module 22 the process of programming and testing a micro-controller 8 is significantly eased as the generation of the configuration program 32 is simplified.

More specifically, as will be described the configuration module 22 simplifies the generation of configuration data by dividing the task into two stages for a user.

Firstly a user is presented with a user interface which enables the user to identify a set of peripherals to be enabled within a micro-controller 8 and the settings for those selected peripherals. The configuration module 22 then utilises the users' selection of peripherals to identify a limited subset of possible configuration settings which are suitable for routing the signals of the selected set of peripherals in and out of the micro-controller 8.

At the same time, a user is presented with a display illustrating the physical locations of the inputs and outputs for the micro-controller 8 which result from the identified sets of possible configuration settings. Thus rather than having to consider all possible settings for a micro-controller 8, the user can make a desired selection from the illustrated subset using the available feedback on how different configuration settings vary the physical locations of where the signals for the selected peripherals are received and output by the micro-controller 8. When a user identifies a desired set of settings, a configuration program 32 can then be automatically generated from the data stored by the configuration module 22.

The performance of the micro-controller 8 can then be tested by downloading the binary code derived from the program data 30 by the compiler 26 and assembler 24 and a configuration program 32 from the memory 12 of the computer into the memory of the micro-controller 8. The configuration program 32 then causes the micro-controller 8 to adopt the configuration settings selected by the user via the configuration module 22. The micro-controller 8 will then run the binary code utilising the identified configuration settings and the output by the micro-controller 8 can be analysed in a conventional manner.

Finally, when the performance of the binary code and configuration program 32 are deemed satisfactory, the micro-controllers 8 programmed utilising the program data 30 and configuration program 32 can be produced and incorporated within circuit boards for larger apparatus.

Before describing the structure and function of the configuration module 22, the structure of an exemplary micro-controller 8 will first be described with reference to FIGS. 2 and 3.

Structure of Exemplary Micro-Controller

Referring to FIG. 2 which is a schematic block diagram of micro-controller 8, each micro-controller comprises a main chip 35 on which is provided a clock 36, a central processing unit 37, a program store 38 and a set of peripherals 40-1-40-N each comprising functional blocks arranged to do specific tasks on the chip. Typical functional blocks might be an infrared detector, a counter, a capture timer or a UART etc. The precise peripherals available on a particular chip will vary from micro-controller to micro-controller. controller.

The main chip 35 is connected to a circuit board 7 by a series of pins 42. These pins 42 are arranged to route signals from the rest of circuit board to the main chip 35. Frequently, a micro-controller 8 will be set up so that the number of the number of input and outputs that can be processed by the CPU 37 and peripherals 40-1-40-N on the main chip 35 will exceed the number of pins 42 available to route signals in and out of the main chip 35. This is because normally only a subset of the peripherals 40-1-40-N will be utilised in any particular application.

In order to provide flexibility as to which sets of peripherals can be used together and also to enable signals to be routed to different pins 42, the pins 42 are divided into groups of pins. These groups are shown in FIG. 2 as ports A-K 45-56 and a port comprising a set of control signals 57. Each of these ports comprises a group of pins where the ports in FIG. 2 are shown as comprising eight pins each with the exception of port K 50 and port L 49 having four pins and the port 57 comprising a set of control signal pins having sixteen pins. With the exception of the set of pins 57 associated with control signals, each of the remaining ports 55-56 is associated with a selector 60 and a register 62. Each selector 60 is connected to peripherals 40-1-40-N on the main chip 35 via a set of wirings 63. Each selector 60 is then arranged to select which of the signals transferred via the wirings 63 are connected to the pins connected to the selector 60 on the basis of data stored in the register 62 associated with that selector 60.

Thus by storing appropriate register values in the registers 62 it is possible to configure the micro-controller 8 so that different signals from the peripherals 40-1-40-N are connected to selected ones of the pins 42 connecting the micro-controller 8 to the circuit board 7.

In addition to the registers 62 which need to be programmed to enable a suitable set of signals to be routed via the pins 42, in a typical micro-controller, the clock 36 and each of the peripherals 40-1-40-N will also each have a set of registers 64, 65-1-65-N associated with them which enable the individual parameters of the clock 36 and the peripherals to be tailored to the particular function that the micro-controller 8 is to be performed.

By way of example, FIG. 3 is a schematic block diagram of a typical clock 36 available on a micro-controller 8. A typical clock might comprise a low oscillator 80 arranged to generate a clock signal having a frequency of 32 Khz and a high oscillator 82 arranged to generate a clock signal having a frequency of 5 Mhz. Additionally the clock might comprise a low PLL 84 arranged to generate a 5 Mhz clock signal using the 32 Khz signal from the low oscillator 80 and a high PLL 86 arranged to convert the clock signal generated by the high oscillator 82 into a clock signal having a frequency of 100 Mhz. In this way, the clock 36 would be able to generate a set of four clock signals each of which might form the basis of the main clock for the micro-controller 8.

To enable a user to select which signal should be utilised as a main clock signal, the low oscillator 80, low PLL 84, high oscillator 82 and high PLL 86 are then all connected to a selector 87 which is in turn connected to a register 88 which, in this example, would be a two bit register. By storing an appropriate value in the register 88 the selector 87 is arranged to determine which the clock signals generated by the low oscillator 88, the low PLL 84, the high oscillator 82 or the high PLL 86 is to be used as a base clock frequency.

Additionally, a clock 36 might also comprise a pair of dividers 90,91 arranged to derive different frequency clock signals from the main clock signal selected by the selector 87 by dividing the clock by a preset value. These preset values are stored within further registers 92,94 associated with each of the dividers 90,91. Thus in this way a set of different clock signals all based on the master clock signal selected by the selector 87 will be derived and output by the clock module 36 and utilised by the CPU 37 and peripherals 40-1-40-N on the main chip 35. Thus in order to enable the clock module 36 to output appropriate signals, further configuration data needs to be stored in the registers 92,94 of the clock.

In order to program a micro-controller 8 three sets of data therefore need to be generated and stored. First of all, binary code needs to be generated and stored within the program store 38 of the main chip 35 which can then be processed and run by the CPU 37 of the main chip 35. This code can be generated from program data 30 by a compiler 26, assembler 27 and amended by a debugger 28 in a conventional manner.

Additionally however, configuration data for each of the peripherals 40-1-40-N and the clock 36 needs to be created and stored within the registers 64,65-1-65-N so as to configure the peripherals 40-1-40-N and the clock 36 to set these peripherals and clocks to perform the dedicated functions that they are arranged to perform. Configuration data needs also to be stored within the registers 62 associated with each of the ports 45-56 to enable signals utilised by the various peripherals to be routed to and from appropriate pins 42 connecting the micro-controller 8 to the circuit board 7.

The structure and function of a configuration module 22 which enables a user to generate all the required configuration data easily and efficiently will now be described with reference to FIGS. 4-13.

Overview of Functional Components of the Configuration Module

FIG. 4 is a schematic block diagram of the sub-components of the configuration module 22 in accordance with this embodiment of the invention.

In this embodiment the configuration module 22 comprises: an interface generator 100 arranged to receive instructions via the keyboard 4 and mouse 3 and display a user interface on the display screen 2; a configuration checking module 102 arranged to determine which settings for the registers 62 associated with ports 45-56 of a micro-controller 8 are compatible with a selected set of peripherals; a code generation module 104 arranged to generate a configuration program 32 for causing appropriate values to be stored in the registers 62 for a particular selection of peripherals 40-1-40-N; and an output module 106 arranged to utilise data identifying selected sets of peripherals and port configurations to generate and output schematic diagrams and printed circuit board diagrams for an identified configuration of a micro-controller 8.

In addition to the functional modules described above, the configuration module 22 also comprises: a peripheral database 108 storing data defining the signals and potential settings of each peripherals 40-1-40-N and the clock 36 available on a particular micro-controller 8; a set of configuration tables 110 comprising tables indicating which signals are connected to which pins 42 on a micro-controller 8 when different values are stored in the registers 62 associated with the ports 45-56 of the micro-controller 8; a preferred input list 112 indicating which pins 42 are preferably utilised by peripherals 40-1-40-N for receiving input signals; a rules database 114 comprising data defining the requirements for the compatibility of different settings within individual peripherals 40-1-10-N and the clock 36; a set of default pin names 116 being labels for identifying default names associated with each of the pins 42 connecting a micro-controller 8 to a circuit board 7; and data defining a set of default configuration values 118 for storage in the registers 62 of the micro-controller when no other value for a register is prescribed.

Finally, in use the configuration module 22 is also arranged to store configuration data 119 identifying acceptable configuration values for storing in registers 62 for a particular selection of peripherals and a selected peripheral database 120 for storing a set of selected peripheral records identifying those selected peripherals and the proposed register values for storing in the registers 65-1-65-N associated with the selected peripherals together with a record for the clock 36 and its registers 64.

FIG. 5 is a schematic block diagram of a record within the peripheral database 108 of the configuration module 22. In this embodiment a peripheral record 121 is stored within the peripheral database 108 for each of the peripherals 40-1-40-N available in a micro-controller 8, together with an additional record associated with the clock 36 and any other global parameters such as data associated with general purpose input output pins for the micro-controller 8.

In this embodiment each peripheral record 121 comprises: name data identifying the name of the peripheral 122; a list of signals 123 indicating the inputs and outputs associated with the peripheral for that record; and status data 124 identifying for each entry in the list of signals 123 whether a particular signal is an input or an output or both an input and an output.

Thus for example a peripheral record for an asynchronous receive and transmit module might comprise the following data:

| | |
|---|---|
| Peripheral Name: | UARTA |
| List of Signals: | UARTA_TX, UARTA_RX |
| Status Data: | Output, Input |

In addition, each peripheral record 121 also comprises a list of register names 125, a set of register records 126 and a set of variable values 127. The number of register names 125, register records 126 and variable values 127 will vary from peripheral to peripheral.

The list of register names identifies the function of each register 64,65-1-65-N included in the peripheral which the peripheral record represents. Thus in the case of a record for the clock for the exemplary clock of FIG. 3 the following register names might be stored:

Low frequency clock frequency

High frequency clock frequency

In-clock frequency

Free-run clock frequency

CPU—clock frequency

The register records 126 comprise a record for each possible value of a register 64,65-1; 65-N associated with the peripheral for which the peripheral record 121 represents which is able to adopt one of a fixed number of settings. Each register record 121 comprises a register number 130 identifying the register within the peripheral to which the register record 126 relates; a value 132 being a possible setting for the register identified by the record 126; and a setting 134 being a text explanation of the effect of setting the identified register identified by the register number 130 to the value 132 identified by the record 126.

Thus for example in the case of the exemplary clock of FIG. 3, the following register records 126 might be stored in relation to the register 88 for selecting a source signal:

| | |
|---|---|
| Register No: | 88 |
| Value: | 00 |
| Setting: | Low frequency clock |
| Register No: | 88 |
| Value: | 01 |
| Setting: | High frequency clock |
| etc. | |

Similarly the variable values 127 of the peripheral records 121 comprise text data identifying the effect of setting variables associated with the peripheral for the peripheral record 121 to different values.

Configuration Tables

FIG. 6 is an exemplary illustration of a configuration table 110 in accordance with this embodiment of the present invention.

In this embodiment a configuration table is stored for each of the ports 45-56 of the micro-controller 8 for which the configuration module 22 is arranged to generate configuration data. Each of the configuration tables comprises a set of pin numbers comprising numbers 135 identifying the pins associated with that particular port and a series of signal labels 136 associated with the port when particular values identified as channel values are stored in the register 62 for that port.

Conventionally, pin numbers for a chip are assigned counting anti clockwise from a designated corner of a chip. Although in the schematic illustration of FIG. 2, pins associated with the same port are shown grouped together, in actual micro-controllers there is no requirement that the pins associated with the port are necessarily physically adjacent pins, rather the definition of a port comprises a set of pins associated with the same selector 60 and register 62. Thus in the illustration of FIG. 6, a set of pin numbers 135 for an exemplary port of four pins are shown to be four pins numbered 62, 64, 65 and 66, with a pin for number 63 being assigned to a different port.

In addition to a set of pin numbers 135 each configuration table also comprises data 136 identifying which signals are potentially connected to which pin associated with a particular port when the value corresponding to the channel value is stored in the register 62.

Thus in the example of FIG. 6 when a value of zero is stored within the register 62 associated with the selector 60 for the port represented by the table, a wake up signal WAKEUP for waking up the CPU 37 is allocated to pin 62 and stream acknowledge STREAM_ACK, stream status STREAM_STS and steam request STREAM_REQ signals are input and output for a serial network interface via pins 64, 65 and 66, if a serial input interface has been selected as one of the peripherals to be utilised by the micro-controller 8.

As can be seen from the exemplary table of FIG. 6, varying the values stored within a register 62 can cause different signals to be connected onto different pins. Conversely in the case of, for example, the wake up signal WAKEUP in the table of FIG. 6 this signal is received by pin 62 both when the register associated with the port for the table is set to zero or alternatively set to three. As will be described in detail later the data stored within the configuration tables 110 enables the configuration checking module 102 to identify sets of possible register values which enable a selected set of peripherals to be utilised within a micro-controller 8 without the signals from the peripherals 40-1-40-N conflicting with one another as they attempt to be output or received on the same pins.

Selected Peripheral Database

FIG. 7 is a schematic block diagram of data stored within the selected peripheral database 120. Initially, in this embodiment the selected peripheral database is arranged to store a single peripheral record 140 for the clock module 36 of a micro-controller. As will be described, in use additional peripheral records 140 are added to the database 120 as different peripherals are identified by a user via the configuration module 22 as being required for use.

The peripheral records 140 stored in the selected peripheral database 120 each comprise a peripheral name 141 corresponding to the peripheral name 122 for the selected peripheral from the peripheral record 121 from a peripheral database 108; a set of register values 142 and variables values 143 being a set of current settings for registers and variables associated with the peripheral identified by the peripheral name 141 of the record; and a location 144 being a pair of x y co-ordinates identifying where within a screen display generated by the interface generator 100 a box displaying the peripheral's name 141 should be shown to represent the presence of the identified peripheral as being enabled within the micro-controller 8.

Processing of the Configuration Module

The processing of the configuration module 22 will now be described with reference to FIGS. 8-13.

Referring to FIG. 8 which is a flow diagram of the processing of the configuration module 22, initially when the configuration module 22 is first invoked the interface generator 100 causes (S8-1) an initial user interface screen to be displayed on the display screen 2.

FIG. 9 is an exemplary illustration of an initial user interface display 145 in accordance with this embodiment of the present invention. From left to right, the user interface display 145 comprises a peripheral window 150 displaying a series of icons 151, one associated with each of the peripherals 40-1-40-N present within the micro-controller 8 for which configuration data can be generated; and a main window 152 within which is shown a schematic representation 154 of the micro-controller 8 for which configuration data is to be generated.

In this embodiment, the schematic representation 154 has at its edge representation of the pins 42 of a micro-controller, each of the pins being associated with a label 156 which initially corresponds to the default pin name 116 associated with the pin number identified by the default pin names data 116 stored within the configuration module 22. These pin names are arranged in order of pin number and hence illustrate the relative locations of inputs and outputs identified by the pin labels 156 relative to a unique mark 157 at one corner of the micro-controller 8 which is also illustrated as a mark 157 on the schematic illustration 154 of the controller 8.

Finally, the user interface display 145 also comprises at the right hand side, a configuration window 160 within which is displayed port configuration data 162 identifying the current register settings for each of the registers 62 for the ports 45-56 of the micro-controller 8 for which configuration data is to be generated together with a number indicating the number of pins associated with general purpose inputs and outputs within the current configuration 163. Initially the settings will be those which correspond to the default configuration values 118 stored within the configuration module 22.

At the bottom edge of this port configuration window 160 are a set of configuration buttons 164 for selecting between currently applicable configurations represented by configuration data 119 stored within the configuration module 22. When the apparatus is first invoked the stored configuration data 119 will comprise data identifying a single configuration comprising a set of null values one for each of the ports which as will be described will cause the port configuration window 160 to display a port configuration data 162 corresponding to the stored default configuration 118 and the pin labels 156 to correspond to the stored default pin names 116.

Utilising a pointer 165 under the control of the mouse 3, a user is then able to select various areas of the user interface display screen 145 which causes the configuration module 22 to vary the displayed user interface display 145 and the data stored in the selected peripheral database 120 and configuration data 119 so a user can choose appropriate register settings for a micro-controller 8 as will now be described.

Returning to FIG. 8, once the interface generator 100 has displayed an initial user interface display 145 on the screen 2, the interface generator then (S8-2) checks whether a user has selected any of the representations of peripherals 151 in the peripheral window 150 using the pointer 165 under the control of the mouse 3. In this embodiment, selection of the representation of a peripheral 151 is utilised to enable a user to identify that they wish a particular peripheral to be available for use on the micro-controller 8.

If this is the case the interface generator 100 then (S8-3) creates a new selected peripheral record 140 and stores the record 140 in the selected peripheral database 120. In the newly generated selected peripheral record 140, the peripheral name 141 is set to the peripheral name 122 of the peripheral record 121 corresponding to the selected peripheral from the list of peripherals 151. The register values and variable values 142, 143 are then set to default values for the selected peripheral and the x y location is set to track the pointer 165 until the user releases the button on the mouse 3.

Thus for example if the SCI-smart card interface icon at the top of the peripheral window were to be selected, the following record would be generated stored:

| | |
|---|---|
| Peripheral Name: | SCI |
| Register Values: | 0, 0, 0, 0, 0, 0 |
| Variable Values: | None |
| Location: | x y co-ordinates of pointer |

The interface generator 100 then causes a square block centered on the location 144 identified by the new peripheral record 140 to be displayed on the screen 2 where text corresponding to the peripheral name 141 of the newly created peripheral record 140 appears in the block.

The configuration module 22 then invokes the configuration checking module 102 to determine (S8-4) a set of possible port configurations enabling the input and output of signals corresponding to the set of peripherals for which peripheral records 140 have now been stored.

Referring to FIG. 10 which is a flow diagram of the processing of the configuration checking module 102, after a new peripheral record 140 has been stored in the selected peripheral database 120, the configuration checking module 102 initially proceeds to determine (S10-1) the port channel settings which may be affected by the inclusion of this additional peripheral.

More specifically, the configuration checking module 102 initially identifies the list of signals 123 for the peripheral record 121 having a peripheral name 122 corresponding to the peripheral name 141 of the newly generated selected peripheral record 140.

Thus for example in a case of storing a new selected peripheral record 140 for the peripheral UART A previously described the list of signals 123 would comprise the list: UART A_RX and UART A_TX.

The configuration checking module 102 then proceeds to identify the configuration tables 110 and channel values 136 which are associated with any of the identified signals. This is achieved by utilising the configuration tables 110 as lookup tables to determine a set of possible ports and channel values which may be affected by the addition of the new peripheral.

Thus for example for a particular peripheral the configuration checking module 102 might identify that the signals utilised by that peripheral are associated with the table for port D when a channel value is set to 1, and also with the table for port K when the channel value is set to 2.

The configuration checking module 102 then proceeds to identify all possible combinations of the identified set of channel settings. Thus in the case of the example above three combinations namely: setting port D to channel 1, port K to channel 2 or setting both port D to channel 1 and port K to channel 2 would be identified.

Having identified this set of possible affected port settings, the configuration checking module 102 then (S10-2) determines for each identified combination of port settings a complete list of the signals associated with those port settings. These values are read off from the configuration tables 110 using the identified combinations.

The configuration checking module 102 then checks that for each of the combinations whether the list of signals includes all of the entries in the list of signals 123 associated with the peripheral for which new selected peripheral record 140 has just been stored. If this is not the case the identified combination of port settings is deleted.

Thus in this way the configuration checking module 102 identifies a set of combinations of port settings which are sufficient to enable all of the signals required by the newly selected peripheral to be input and output.

The configuration checking module 102 then (S10-3) proceeds to process each of the identified acceptable combinations in turn. Specifically, the port settings associated with a particular combination are compared with each existing entry in the configuration database 119, which in this embodiment each comprise a series of values, one for each of the ports 45-56 where the entries can take any of the channel settings for an associated port or alternatively a null value. If the combination of port configuration currently being processed identifies null values in an item of configuration data or alternatively identify the same port setting values as the port setting identified for a particular port by an item of configuration data, a new item of configuration data is generated and stored.

In this embodiment, each new item of generated configuration data comprises a copy of the item of configuration data being processed with the port setting values of any null values corresponding to the affected identified ports set to the corresponding port setting identified by the combination currently being considered.

Thus for example, processing the following identified possible affected sets of combinations of port settings against the following stored items of configuration data:

D = 1
K = 2
D = 1 and K = 2

| | A | B | C | D | E | F | G | H | I | J | K | L |
|---|---|---|---|---|---|---|---|---|---|---|---|---|
| Config 1 | 1 | _{—} | _{—} | _{—} | _{—} | _{—} | _{—} | _{—} | _{—} | _{—} | 1 | _{—} |
| Config 2 | _{—} | _{—} | _{—} | _{—} | 4 | _{—} | _{—} | _{—} | 5 | _{—} | _{—} | _{—} |

where_indicates a null value for a channel; after all the combinations had been processed the following items of configuration data would be stored:

| | A | B | C | D | E | F | G | H | I | J | K | L |
|---|---|---|---|---|---|---|---|---|---|---|---|---|
| Config 1 | 1 | _{—} | _{—} | 1 | _{—} | _{—} | _{—} | _{—} | _{—} | _{—} | 1 | _{—} |
| Config 2 | _{—} | _{—} | _{—} | 1 | 4 | _{—} | _{—} | _{—} | 5 | _{—} | _{—} | _{—} |
| Config 3 | _{—} | _{—} | _{—} | _{—} | 4 | _{—} | _{—} | _{—} | 5 | _{—} | 2 | _{—} |
| Config 4 | _{—} | _{—} | _{—} | 1 | 4 | _{—} | _{—} | _{—} | 5 | _{—} | 2 | _{—} |

After the configuration checking module 102 has processed all identified affected combinations of port settings, the configuration checking module 102 then determines (S10-4) whether any new items of configuration data have been stored. If no new items have been stored, this indicates that the addition of the new peripheral is incompatible with the set of peripherals previously selected and there are no possible port settings which can enable all of the selected set of peripherals to receive and output all the signals associated with those peripherals. The configuration checking module 102 then notes this error (S10-5).

Returning to FIG. 8, if after the processing of the configuration checking module 102 it is determined that no possible set of configuration can accommodate the selected set of peripherals (S8-5), the interface generator 100 proceeds to delete the newly generated selected peripheral record 140 and display a warning identifying why the selected peripheral can not be added to the currently selected list. This warning is generated by utilising the generated list of affected port settings for the new peripheral and identifying which other selected peripherals cause the identified ports are to be set to alternative values.

Returning to FIG. 10, if new items of configuration data are generated, these are used to replace the previously stored configuration data 119. The configuration checking module 102 then calculates for each item of confirmation data, an associated set of pin names. In this embodiment, this is achieved by taking each pin associated with a port 45-46 in turn and identifying a pin label for that pin the configuration table which relates to that pin and a pin label for that pin using the port settings identified by the configuration data.

When a complete list of pin names has been generated, the configuration module 102 checks for each of the set of pin labels, whether the labels correspond to either a general input/output label or to a signal in the list of signals 123 of one of the peripherals having a peripheral name 122 corresponding to the peripheral name 141 of any of the selected peripheral records 140. If this is not the case the label for a pin is reset to be the default label for that pin using the stored default pin names 116. Finally, the items of configuration data are then sorted on the basis of the number of general inputs and outputs included in the list of pin names associated with each item of the configuration data.

Once the pin labels have been generated and the configuration data 119 ordered in order of increasing numbers of included general purpose inputs and outputs, the configuration checking module 102 (S10-7) then processes each generated list of pin names to identify for each whether the configuration data includes any duplicate representations of any signals identified as input signals by status data 125 in the peripheral database 108. If this is the case the configuration checking module 102 utilises the preferred input list 112 to set the pin labels for any duplicate inputs other than the preferred inputs to the default pin names for those pins as indicated by the default pin names 116 of the configuration module 102.

Finally, the configuration checking module 102 causes (S10-8) the interface generation module 100 to update the user interface display 145, by re-labelling the representations of the pins with pin labels 156 corresponding to the pin labels for the item of configuration data associated with the greatest number of general purpose inputs and outputs and by connecting the boxes representing the selected peripherals via lines to the pins associated with signals for the selected peripherals.

FIG. 11 is an exemplary illustration of the user interface display 145 after a number of peripherals have been selected using the user interface 145. Comparing FIG. 11 with FIG. 9, it can be seen that shown within the main window 152 are nine square blocks each associated with a different previously selected peripheral. Also comparing FIGS. 9 and 11 it can be seen that the pin labels 156 have been updated so as to reflect the change of purpose of these pins as the illustrated peripherals have been enabled. Finally, comparing the configuration window 160 in FIGS. 9 and 11, the configuration data 162 has been varied so as to correspond to the port setting of the currently selected item of configuration data indicating null values are replaced by the default values 118 for those ports and the calculated number of general input output lines 163 has also been updated as has the number of available configurations displayed as part of the set of configuration buttons 164.

Returning to FIG. 8, if the interface generator 100 determines (S8-2) that a user has not selected one of the entries in the list of peripherals 151 in the peripheral window 150, the interface generator 100 then checks (S8-7) to see whether a user has selected one of the boxes 167 representing a selected peripheral within the main window 152.

If this is the case the interface generator 100 then (S8-8) checks whether the box 167 has been selected utilising the left or the right mouse button. If the box 167 has been selected utilising the left mouse button whilst the button is depressed the interface generator 100 proceeds to vary the location co-ordinates 144 for the selected peripheral with the location of the pointer 165.

When the left button is released the interface generator 100 checks (S8-10) whether the co-ordinates 144 of the pointer 165 identify a position outside of the area of the main window 152. If this is not the case the interface generator updates (S8-11) the user interface display by relocating the box 167 representing the selected peripheral so as to be centered on the co-ordinates of the pointer 165.

Conversely, if the interface generator 100 determines (S8-10) that the co-ordinates of the pointer 165 identify a position outside the area of the main window 152, this is taken to indicate that the user wishes to remove the selected peripheral from the set of peripherals currently shown as being active within the micro-controller 8. The interface generator 100 therefore deletes the selected peripheral record 140 for the selected peripheral from within the selected peripheral database 120 and updates the display within the main window 152 by deleting the box 167 representing the selected peripheral. The interface generator 100 then invokes the configuration checking module 102 to update the configuration data 119 to account for the deletion of the selected peripheral and to re label the pins 152 appearing in the display 145 accordingly as will now be described with reference to FIG. 12.

Referring to FIG. 12 which is a flow diagram of the processing performed by the configuration checking module 102, at this stage the selected peripheral database 120 will have stored within it a set of selected peripheral records 140 which represent a selection of peripherals which are compatible with one another. That is to say there is at least one set of port configurations which will enable all of the selected peripherals to receive and output all their required signals.

In order to generate a new set of configuration data 119 the configuration checking module 102 initially (S12-1) selects the first peripheral record 140 for a peripheral and proceeds to identify (S12-2) the ports which output and receive signals relating to the peripheral identified by the first peripheral record in the same way that has previously been described for updating configuration data in relation to FIG. 10 in step (S10-1).

The configuration checking module 102 then generates a set of items of configuration data by identifying (S12-3) which of the identified possible combinations of affected port settings enable all of the inputs and outputs of the first peripheral to be received and output. The configuration checking module 102 then generates and stores items of configuration data 119 for each of the combination of port settings for which a complete set of inputs and outputs for the selected peripherals can be received and output. These generated items of configuration data 119 comprise configuration data 119 where the port settings identify the port settings for the identified combinations and all the remaining port settings are represented by null values.

The configuration checking module 102 then (S12-4) checks whether the final peripheral record 140 within the selected peripheral database 120 has been reached If this is not the case, the next selected peripheral record 140 is processed (S12-5) and a set of affected port settings for that peripheral are then identified (S12-6). The possible combinations of affected port settings for that peripheral are then filtered (S12-7) to remove those combinations which do not enable a complete signal set to be received and output by the peripheral currently being considered. This identified set of possible combinations is then used to generate further items of configuration data (S12-8) by determining which combinations are compatible with the currently stored items of configuration data in the same way as has previously been described in relation to step (S10-3) in FIG. 10.

This process (S12-4-S12-8) is repeated for each successive selected peripheral record 140 until the final peripheral record 140 within the selected peripheral database 120 is reached.

At this stage the configuration module 22 will have stored within it configuration data 119 identifying all the possible port configurations will enable all the required signals of the currently selected set of peripherals to be input or output. In the same way as has previously been described, in relation to steps (S10-6-S10-8), the configuration checking module 102 then (S12-9) determines a list of pin names for each item of stored configuration data 119 and then orders the combinations by the number of general inputs and outputs present in each list of pin names. The configuration checking module 102 then (S12-10) checks each of the generated lists of pin names to identify any duplicate representations of any input signals for any of the selected peripherals and whenever this is detected, the configuration checking module 102 utilises the preferred input list 112 to identify which of the inputs is a preferred input and alters the pin name for any remaining duplicate inputs to the default pin names 116 for those pins.

Finally, the configuration checking module 102 causes (S12-11) the interface generator 100 to use the configuration data and set of pin names for the item of configuration data 119 associated the greatest number of general inputs and outputs to re label 156 the representations of the pins in the main window 152, and update the port configuration data 162 in the configuration window 160. The interface generator 100 then causes representations of lines connecting each of the boxes representing peripherals 167 to the respective inputs and outputs associated with those peripherals as labelled by the pin data 156 to be updated to illustrate the currently selected configuration.

Thus in this way by selecting a set of peripherals from the peripheral list 151 and removing peripherals from within the main window 152 a user is able to make an identification of a set of peripherals the user wishes to be enabled on the micro-controller 8. At the same time for each selection the configuration checking module 102 determines a set of items of configuration data identifying required port settings for enabling the signals associated with a currently selected set of peripherals to be output and identifies when an incompatible selection of peripherals has been made and why such a selected set of peripherals is incompatible.

Further as discussed the configuration module 22 also causes a schematic representation 154 of a micro-controller 8 to be displayed together with a set of pin names 156 indicating the purpose of each pin of the micro-controller for a given set of peripherals when a particular set of port settings is selected which is compatible with the identified selection of peripherals is chosen.

Returning to FIG. 8, if the interface generation module 100 determines that the user has not selected one of the boxes 167 representing a selected peripheral (S8-7), the interface generator 100 then (S8-13) checks whether the area of the representation of the micro-controller 154 has been selected.

If this is the case, this is used in this embodiment to enable the user to enter data to identify settings for the clock module 36 present in the micro-controller 8.

More specifically, initially the user interface generator 100 identifies the record within the peripheral database 108 and the selected peripherals database 120 corresponding to the clock module (S8-14) and then causes the interface generator 100 to generate a display menu (S8-15) for enabling the user to vary the current clock settings.

FIG. 13 is an exemplary illustration of a user interface display menu for varying the settings for a clock 36 on a micro-controller 8. As shown in FIG. 13, the menu comprises a list of register names 200 which correspond to the register names 125 of the selected peripheral record 121 from the peripheral database 108, next to which are displayed a series of current values 202 which comprise the setting explanations 134 being the explanations corresponding to the register values and variable values 142, 143 for the selected peripheral.

When an individual register is selected using the pointer 165 under the control of the mouse 3 a drop down menu 204 then appears identifying all the possible settings 134 for a register, or alternatively a box enabling a user to enter a variable value 127 is displayed. A user can then vary the current settings by entering data selecting an entry from the menu 204 or entering data via the keyboard 4.

If after changing the values the user is satisfied with those settings, the user then selects the OK button 206 using the pointer 165. This then causes the interface generator 100 to update the register values 142 and variable values 143 for the selected peripheral so as to correspond to the selected settings. Alternatively the user can select the Cancel button 207 in which case the register values for the selected peripheral 142 are not updated. After either the OK button 206 or the Cancel button 207 is selected an interface generator 100 reverts to displaying the main display 145.

In a similar way, when the interface generator 102 determines (S8-8) that a box 167 representing as existing peripheral has been selected using the right mouse button, a similar display menu is generated for inputting and varying the settings associated with the selected peripheral. The register values 142 and variable values 143 of the selected peripheral record 140 for the selected peripheral are then updated in the same way in which the variables for the clock have been described as being updated. Similarly, after any changes have been made and the OK button is selected, the corresponding register values 142 and variable values 143 for the selected peripheral record 140 are updated (S8-16).

Thus in this way a user is able to vary the default settings associated with individual peripheral records 140 and thus identify required values to be stored in registers 65-1-65-N; 88; 92,94 for the selected peripherals.

Returning to FIG. 8, if the interface generator 100 determines (S8-13) that a user has not selected an area corresponding to the chip 154 the interface generator 100 then (S8-17) checks whether any of the configuration controls 164 on the user interface screen have been selected.

In this embodiment the configuration controls 164 comprise a series of buttons for selecting a first, a previous, the next or the last of the items of configuration data 119 stored by the configuration module. When one of the buttons is selected, the item of configuration data identified by the selected button relative to the item of configuration data currently being utilised to generate a display is utilised to generate (S8-19) a new user interface display 145. This is achieved by re-labelling the pins 156 using the pin labels associated with the newly selected item of configuration data, updating the configuration window 160 and reconnecting the blocks 167 representing the peripherals.

Thus by selecting the different buttons on the configuration control panel 164 the user is able to scroll between different acceptable configurations for the currently selected set of peripherals. In doing so, as the pin labels on a display correspond to physical positions of physical pins on an actual micro-controller 8 the user is able to see the physical locations where various different inputs and outputs for peripherals will be present based on the different port settings. Thus in this way possible port settings may be reviewed and a preferred set of port setting for a particular set of selected peripherals can be identified.

Since configuration data is only stored for port settings which are suitable for receiving and outputting signals for the currently selected set of peripherals, only a limited number of possible port setting combinations need to be reviewed by a user. This limited selection is further reduced in the present embodiment by utilising default values for any port setting which corresponds to a null value in an item of configuration data. Thus a user does not have to review any duplicate combinations whose varying port setting has no affect on inputs or outputs of the currently selected set of peripherals.

After checking (S8-17) whether any of the configuration buttons have been selected 164 the interface generator 100 then (S8-20) checks whether a user has input an instruction to build a configuration program 32 to configure a micro-controller 8 with configurations corresponding to the currently selected settings and port configurations. If this is not the case, the interface generator 100 checks once again whether a user has utilised the pointer 165 to select any of the peripherals displayed within the peripheral window 150 (S8-2).

When the interface generator 100 determines (S8-20) that an instruction to generate a configuration program 32 has been entered, the output module 106 is then invoked. The output module 106 initially (S8-21) checks whether the register settings for individual peripherals and the clock are compatible. This is achieved by utilising rules within the rules database 114 and the register values 142 and variable values 143 for the selected peripheral records 140 within a selected peripheral database 120. A typical reason for there being some kind of incompatibility might be the selected baud rate for a peripheral being incompatible with a possible clock signals which can be generated based on the settings for the clock 36.

If the output module 106 determines that any register settings are incompatible, the output module 106 displays (S8-22) an error message (S8-22) identifying the incompatibility of settings so that a user can adjust these settings accordingly.

If the output module 106 determines (S8-21) that there is no mismatch between the settings of different peripherals and clocks, the output module 106 then invokes the code generation module 104 which utilises the item of configuration currently selected for generating a display and the register values 142 and variable values 143 for the peripheral records 140 within the selected peripheral database 140 to generate a configuration program 32 for setting the corresponding values within the registers 62,64,65-1; 65-N of a micro-controller 8 so that a micro-controller 8 will be configured in the manner corresponding to that illustrated by the user interface.

More specifically, register values for each of the registers 65-1-65-N of the selected peripherals are determined from the register values 142 and variable values 143 of the selected peripherals records 140 stored in the selected peripheral database 120. Similarly, register values for the registers 64 associated with the clock 36 are determined from the register values 142 and variable values 143 of the selected peripheral record 140 associated with the clock. Finally, register values for the registers 62 associated with each of the ports 45-46 are determined from the item of configuration data currently being utilised to generate the user interface display 145 with any null values reset to default values identified by the stored default configuration data 118.

The code generation module 104 therefore utilises the stored selected peripheral records 140 and the currently selected item of configuration data 119 to generate a configuration program 32 for causing the micro-controller 8 to store the identified register values in the appropriate registers 62,64,65-1-N-65-N in the micro-controller 8.

This generated configuration program 32 is then stored in the memory 11 of the computer. The configuration program 32 then can be downloaded into the micro-controller 8 on the circuit board 7 via the interface 6 which configures the micro-controller 8 in a manner corresponding to the selected configuration data so that other program data 30 can be tested utilising the selected register settings of the micro-controller 8 to determine whether the combination of these settings and the compiled program data 30 cause the micro-controller 8 to perform the desired functions.

In this embodiment, in addition to generating a configuration program 32 for causing a micro-controller to adopt a set of identified settings the output module 106, is also arranged generate data for printing representations of the micro-controller 8 in the form of a design schematic representation of the micro-controller 8 showing the inputs and outputs of the micro-controller 8 as identified by the pin labels for the selected configuration where the pin labels are grouped in accordance with the list of signals 123 associated with the selected set of peripherals, and also as a physical representation of a micro-controller 8 or printed circuit board where the pins are labelled in accordance with the physical positions of pins in a similar manner to the schematic representation 154 in the user interface display 145.

Further in this embodiment, the output module 106 is also arranged to generate data representing these illustrations in a form that they can be exported to other software packages for, for example, designing a printed circuit board for use with the micro-controller 8 having been set up as determined by the configuration data and register settings and performing electrical compatibility checking for the configured micro-controller 8 and other chips to be present on a circuit board 7.

### SECOND EMBODIMENT

A second embodiment of the present invention will now be described with reference to FIGS. 14-21.

In the first embodiment a computer system for performing in-line testing of a micro-controller was described where a single micro-controller 8 on a circuit board 7 is tested. Frequently a micro-controller 8 will be attached to a number of external peripherals which are provided on the same circuit board. In this embodiment, a system will be described in which the configuration of a micro-controller can be programmed and in which additionally configuration data for external peripherals can be generated.

Referring to FIG. 14 which is an illustration of a computer system for performing in-line testing in accordance with a second embodiment of the present invention, much of the computer system of FIG. 14 is identical to the system described in relation to the first embodiment and the same reference numerals have been used to identify the elements previously appearing in the system of the first embodiment. In contrast to the first embodiment however, in this embodiment instead of testing a circuit board 7 on which is attached a micro-controller 8 alone, in this embodiment the circuit board being tested 7 has provided thereon a micro-controller 8 and a number of external peripheral chips 300-1-300-N. Typical external peripherals provided on the chip might be a Zigbee chip, an Ethernet connection and one or more USB ports.

When a circuit board including a micro-controller and a number of external peripherals 300-1-300-N is to be programmed, in addition to the configuration of the internal peripherals of the micro-controller 8, any program stored within the memory of the micro-controller 8 is also required to be such to program the registers of the external peripherals 300-1-300-N in a manner which is compatible with the processing of the internal peripherals. Thus for example in the case of a Zigbee chip, a UART internal peripheral will be required to be made available within a micro-controller and the configuration of the internal UART and the Zigbee chip must be made to match in terms of baud rate, parity etc. To that end, in accordance with this embodiment of the present invention in place of the configuration module 22 of the previous embodiment a modified configuration module 302 is provided which facilitates the programming of the micro-controller 8 so as to select appropriate internal peripherals and determine appropriate configuration data for the selected internal peripherals and also connected external peripherals 301-300-N as will now be described.

Modified Configuration Module

FIG. 15 is a schematic block diagram of the sub-components of the modified configuration module 302 in accordance with this embodiment of the invention.

The modified configuration module 302 is substantially identical to the configuration module 22 of the previous embodiment with the addition of including an external peripheral database 304 storing data defining the signals and potential settings of the external peripherals supported by the interactive design environment 20; an external peripheral store 306 operable to store the user selected values for registers associated with the external peripherals and a selection module 308 for processing user input relating to external peripherals as will be described in detail later.

External Peripheral Database

FIG. 16 is a schematic block diagram of an external peripheral record 310 stored within the external peripheral database 304. An external peripheral record 310 is stored within the external peripheral database 304 for each of the external peripherals 300-1-300-N the interactive design environment 20 is arranged to support. The structure of the external peripheral records 310 is similar to the structure of the peripheral records 212 stored within the peripheral database 108. In the same way as the peripheral records 121 previously described, in this embodiment, the external peripheral records 310 comprise name data 122 identifying the name of the peripheral, a list of register names 125, a set of register records 126 and a set of variable values 127 where the register records 126 and variable values is exactly the same as has previously been described.

However, instead of having a list of signals 123 and status data 124, in this embodiment, the external peripheral records 310 each include preferred connection data 312 identifying for an external peripheral the internal peripheral preferred to be made available within a micro-controller 8 to enable the micro-controller 8 to communicate with an external peripheral; a list of connection requirements 313 identifying for the external peripheral register values and variables such as baud rate which are required to be matched between an internal peripheral and an external peripheral; and a set of virtual requirements 314 identifying a set of input and output pins for direct communication between a micro-controller and an external peripheral in the event that no suitable internal peripherals for communication can be made available.

Thus for example in the case of an external peripheral comprising a Zigbee chip which ordinarily communicates with a micro-controller via a UART connection, the preferred connection data 312 for an external peripheral record 310 representing a Zigbee chip might comprise:
preferred connections: UART A, UART B

Such an entry would indicate that whenever a Zigbee chip was selected within the interactive design environment 20 preferably the first Zigbee chip selected would be connected to the micro-controller 8 via the internal peripheral UART A. If UART A were to be unavailable for use and the Zigbee chip were to be selected for connection it would be preferably connected via the internal peripheral UART B. Finally if neither UART A nor UART B were available for use, the interactive design environment 20 would then attempt to configure the micro-controller 8 to emulate a further UART connection as will be described later.

External Peripheral Store

FIG. 17 is a schematic block diagram of a number of selected external peripheral records 340 stored within the external peripheral store 306. When the interactive design environment is first invoked, the external peripheral store 306 will store no data. As will be described as representations of external peripherals are selected by a user via the user interface, new selected external peripheral records 340 are stored within the external peripheral store 306.

The selected external peripheral records 340 stored in the external peripheral store 306 are similar to the peripheral records 140 stored in the selected peripheral database 120 for storing internal selected peripheral records 140. In this embodiment the selected external peripheral records 340 each comprise a peripheral name 341 corresponding to a peripheral name 122 for the selected peripheral from the external peripheral record 310 from the external peripheral database 304; a set of register values 342 and variable values 343 being a current set of settings for registers and variables associated with the external peripheral identified by the record; location data 344 being a pair of x,y co-ordinates identifying where within a screen display generated by the interface generator 100 a box is displaying the external peripheral's name 341 should be shown to represent the presence of the identified external peripheral; and connection data 345 identifying the internal peripheral or pin connections connecting the external peripheral represented by the record to the micro-controller 8 as will be described in detail later.

Processing Using the Modified Configuration Module

When the modified configuration module 302 is first invoked the interface generator 100 causes an initial user interface screen to be displayed on the display screen 2. FIG. 18 is an exemplary illustration of an initial user interface display 145 in accordance with this embodiment of the present invention. The user interface display is almost identical to the user interface display initially generated in the first embodiment with the exception that the peripheral window 150 displayed on the left hand side of the user interface is divided into two parts: a first window 150 displaying a series of icons 151 each one associated with each of the internal peripherals 40-1-40-N present within the micro-controller 8 for which configuration data can be generated and a second window 350 displaying a series of icons associated with each of the external peripherals which the interactive design environment 20 is operable to support for which external peripheral records 310 are stored within the external peripheral database 304.

As in the case of the first embodiment using a pointer 165 under the control of the mouse 3 a user is able to select various areas within the user interface display screen 145 which causes the configuration modules 22 to vary the displayed user interface display 145 and the data stored within the selected peripheral database 120, the configuration data 119 and in this embodiment the data stored within the external peripheral store 306.

Once the initial screen has been displayed, the processing in this embodiment is similar to the processing undertaken in the first embodiment. However, when the interface generator 100 checks whether a user has selected any of the representations of the peripherals in the peripheral window 150 or the external peripheral window 350, the processing previously described in relation to FIG. 8 is modified as will now be described referring to FIG. 19.

After it has been determined that one of the icons representing either an internal or external peripheral has been selected, the interface generator 100 determines (S19-1) whether the selected peripheral is an internal peripheral selected from the first window 151 or an external peripheral selected from the window 350. If it is determined that the selected icon represents an internal peripheral, the processing performed proceeds in the same way as has previously been described in relation to steps S8-3 to 8-6 of FIG. 8.

If it is determined that a representation of an external peripheral has been selected, the interface generation module 100 then (S19-2) displays a block representing the newly selected external peripheral and creates a new selected external peripheral record 340 which is stored in the external peripheral store 306. In the newly generated selected external peripheral record 340, the peripheral name 341 is set to the peripheral name 122 of the external peripheral record 310 corresponding to the selected peripheral from the list of external peripherals 350. The register values 342 and variable values 343 are then set to default values for the selected peripheral and the x,y location is set to track the pointer 165 until the user releases the button or mouse.

When the button on the mouse 3 is released, the interface generator 100 invokes the selection module 308 which then utilises the preferred connections data 312 of the external peripheral record 310 having the peripheral name 122 corresponding to the peripheral name 341 of the newly generated selected external peripheral record 340 to select a suitable internal peripheral for connection to the selected external peripheral.

More specifically, the selection module 308 initially identifies the first preferred connection appearing in the list of preferred connections 312 of the external peripheral record 310 having peripheral name 122 corresponding to the peripheral name 341 of the newly generated selected external peripheral record 340. The selection module 308 then checks (S19-4) whether a peripheral record 140 is stored within the selected peripheral database 120 having a peripheral name 122 corresponding to the entry in the list of preferred connections 312 being processed. If this is the case, this will indicate that the identified internal peripheral has already been allocated to some other use and the selection module 308 will then (S19-5) check to determine whether the last entry on the list of preferred connections 312 has been reached. If this is not the case the next entry is then selected and the selection module 308 then determines whether any entries within the selected peripheral database 120 correspond to that next entry

If the selection module 308 determines (S19-4) that the preferred connection under consideration has not already been allocated a user, the selection module 308 proceeds (S19-6) to determine whether the adding of a new peripheral record corresponding to the identified internal peripheral will result in a conflict with pre-existing port configurations in exactly the same way as has previously been described in relation to the first embodiment. If it is determined that the identified internal peripheral cannot co-exist with the internal peripherals identified by records in the selected peripheral database 120, the selection module 308 then (S19-5) checks whether the final peripheral in the list of preferred connections 312 has been reached and if this is not the case the next possible peripheral in the list is selected for consideration (S19-4).

If, however, the selection module 308 determines that activation of the identified internal peripheral is permissible and will not result in a conflict, the selection module 308 then causes the interface generation module 100 to add a representation of the identified internal peripheral to the screen display and store a selected peripheral record 140 identifying the identified internal peripheral in the selected peripheral database 120.

When the new selected peripheral record 140 is stored, the register values 142 and variable values 143 for the new record 140, identified by the connection requirements 313 for the new selected external peripheral record 340, are made to match the corresponding values in that new selected external peripheral record 340. Connection data 345, identifying the peripheral name 121 of the newly stored peripheral record 140 is also stored within that new selected external peripheral record 340. Finally, the interface generation module 100 updates the display showing a connection between the new selected internal and external peripherals via the pins the current configuration data 119 indicates the internal peripheral receives and outputs signals.

FIG. 20 is an exemplary illustration of a user interface after a user has selected the icon corresponding to the Zigbee chip. In the illustration of FIG. 20, a box 355 representing the Zigbee chip is shown associated with a box 360 representing an appropriate internal peripheral, in this example a UART connector UART A.

Once records for the external peripheral 340 and the associated internal peripheral 140 have been stored within the selected peripheral database 120 and the external peripheral store 306 the processing of the interface generation module 100 then proceeds in a similar way as has previously been described in relation to the first embodiment.

If a user selects either of the boxes 355 and 360 representing a peripheral and causes the pointer 165 to be dragged outside the main window 152 this indicates that the peripheral in question is to be deleted. If the box in question represents an external peripheral, in this embodiment this will also be taken as an instruction to delete the internal peripheral connected with that peripheral as identified by stored data in the circular external peripheral record as connection data 345. Similarly when an internal peripheral is deleted the interface generation module will proceed to check whether any of the external peripheral records 340 stored in the external peripheral store 306 has connection data 345 identifying the deleted peripheral and if so delete that record and the representation of that record in the user interface.

If a user selects either representation of an external peripheral 355 or an associated internal peripheral 360 using a right mouse click in a similar way as has previously been described register entries in values associated with that peripheral can be updated. However, so as to ensure that compatible configuration data is stored both for an internal and an external peripheral, in this embodiment when register values or variable values of a peripheral are updated, the interface generation module 100 proceeds to enter corresponding values in the register values and variable values of an associated internal or external peripheral record utilising the connection data 345 and selection requirements 313 to determine which values and registers require updating.

Returning to FIG. 19, if (S19-5) the selection module 308 finds that all of the preferred peripherals in the connection list 312 are identified by peripheral records 140 stored within the selected peripheral database 120 or alternatively that no suitable configuration data can be generated if any of the available internal peripherals are selected, in this embodiment the selection module 308 proceeds to determine (S19-8) whether the micro-controller itself can emulate the required peripheral and output signals on any of the available pins.

As stated previously the virtual requirements list 314 of an external peripheral record 310 identifies the inputs and outputs required by a micro-controller to emulate a required virtual peripheral. After it has been determined that none of the inbuilt internal peripherals can be utilised, in this embodiment the selection module 308 checks the current list of pin names to identify pins which are associated with general input outputs. The selection module 308 in this embodiment then identifies the available general input output pins which are closest in position to the current location of the data 344 of the newly generated peripheral record 340. Once these pins have been identified, the interface generation module 100 then causes a box to be included within the boundaries of the microchip 154 representative of a virtual (i.e. software emulation) of an onboard peripheral of a specific type and stores data identifying the pins as connection data 345 in the newly stored selected external peripheral record 340 in the external peripheral store 306.

FIG. 21 is an illustrative example of a user interface in which after onboard peripherals UARTA and UARTB have been selected and incorporated within the selected interface database 120 and are represented by boxes 370 and 372 within the user interface a user selects a Zigbee chip from the list of external peripherals in the user interface 350 which requires to interface with a UART peripheral. Since no further UARTs are available in this particular example a box representing a virtual UART 375 is included in the user interface and the virtual UART box 375 is shown connected to the box 355 representing the external Zigbee chip.

As in the case of the first embodiment when build is selected from the user interface (step 8-20 in FIG. 8) the output module 106 is invoked. As in the first embodiment the output module 106 initially checks (S8-21) whether register settings for individual peripherals and the clock are compatible and if this is the case proceeds to generate (S8-23) a configuration program 32 for setting the values within the registers of the micro-controller so that the micro-controller is configured in a manner corresponding to that illustrated by the user interface. Additionally in this embodiment the configuration program 32 also is arranged to program the settings for registers associated with external peripherals represented by register values 342 and variable values 343 of selected external peripheral records 340 stored in the external peripheral store 306 and also to generate software code for the emulation of a peripheral and the input and output of signals via identified pins where a virtual peripheral is represented within the user interface.

### FURTHER EMBODIMENTS AND AMENDMENTS

Although in the above embodiments, systems have been described in which a configuration module 22 is arranged to store data defining a representation of a single micro-controller 8 and generate configuration programs 32 specifically for that micro-controller 8, it will be appreciated that in other embodiments a configuration module 22 could be provided for generating configuration programs 32 for a variety of micro-controllers 8.

In such a system, the configuration module 22 would need to store configuration tables 110 and a peripheral database 108 for each possible micro-controller 8. Initially a user could input data and identify a preferred micro-controller 8 for which configuration data 119 was to be generated. The processing of the configuration module 22 then could proceed in the same manner as has previously been described.

An advantage of such a system would be that when the configuration module 22 determined that a particular selection of peripherals could not be utilised on a particular micro-controller 8, the configuration module 22 could utilise the data stored representing other micro-controllers 8 to determine whether any of those other micro-controllers could support the desired set of peripherals. Users could then be prompted to change their selection of micro-controller 8 and the configuration module 22 could then proceed to generate a configuration program 32 for the alternative micro-controller 8.

Although in the above embodiments, the configuration module 22 has been described as ordering items of configuration data 119 on the basis of the number of general inputs and outputs referred to by pin labels for a specific configuration, other means of ordering items of configuration data could be utilised.

Thus for example in an alternative embodiment the lengths of lines representing connections between blocks 167 and pin in the main window 150 could be determined and calculated for each item of configuration data. The items of configuration data would then be ordered on the basis of the calculated values.

An advantage of such a system would be that by placing a block 167 representing a particular peripheral at a certain position on the schematic representation of the micro-controller 154, a user could identify the area of the micro-controller where the user would prefer inputs and outputs for that selected peripheral to be made available.

In the above embodiments, systems are described for generating configuration data registers 62 of micro-controllers 8 controlling the routing of signals where pins 42 are grouped into a number of ports 45-56. In the above described embodiment the number of pins 42 associated with each port is described as being either four or eight.

It will be appreciated that the number of pins associated with any particular port could potentially comprise any number of pins 42. Most importantly, ports could comprise a single pin rather than a set of pins.

In a system where individual selectors 60 and registers 62 are associated with single pins 42 a highly flexible system for varying the location of which pins are utilised to transfer which signals would be provided. The described system for generating configuration data would then enable such highly flexible micro-controllers to be appropriately programmed despite the fact that the increased number of registers would make determining configuration data in a conventional manner a particularly complex task.

Although in the above embodiments, the generation of a configuration program 32 for storage within an internal program store 38 of a micro-controller 8 has been described, it will be appreciated that a generated program for causing a micro-controller 8 to store an identified set of configuration values could be stored within a memory in a circuit board 7 external to the micro-controller 8 rather than within an internal program store 38.

Although in the above embodiments the register values for the registers 64, 65-1-65-N are described as being determined from the stored register and variable values 142,143, it will be appreciated that the actual values stored could be calculated from the register and variable values 142,143 rather than being direct copies of these values. Thus for example by entering a variable value for a baud rate of 32 kHz, a user might cause the configuration module 22 to calculate that a particular value needed to be stored in a register to enable the desired baud rate to be achieved. Alternatively, the user entry of a number of values such as baud rate, tolerance etc could be utilised to calculate a single value for storage in a register 64:65-1; . . . ;65-N in a micro-controller 8.

Although in the above description, reference has been made to micro-controllers 8 controlling the functions of larger apparatus, it will be appreciated that the current invention is applicable to the design and configuration of any micro-chip including a number of peripherals where the routing of signals for those peripherals is controlled through the storage of values within registers in the micro-chip. The term micro-controller should therefore be taken to encompass any such configurable micro-chip including such peripherals and registers.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier can be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A micro-controller configuration apparatus operable to identify a set of register values for storage within registers of a micro-controller which includes a plurality of peripherals, the micro-controller being operable to route different selections of signals to and from said peripherals via a set of ports on the basis of the register values stored in said registers, said configuration apparatus comprising:
a first user input interface operable to enable a user to input data identifying a selection of peripherals from the plurality of peripherals included in said micro-controller;
a determination module operable to determine for input data identifying a selection of peripherals, a set of signals required for routing to and from said selected peripherals to enable each of said peripherals to function, said determination module further being operable to identify a plurality of combinations of register values which when stored within registers of a micro-controller enable all of the determined signals to be routed via ports of said micro-controller;
a second user input interface operable to enable a user to select one of said plurality of combinations of register values identified by said determination module; and
an output module operable to output data identifying a set of register values for storage within registers in a micro-controller including register values corresponding to a selected combination of register values.

2. An apparatus in accordance with claim 1 wherein said determination module comprises:
a plurality of configuration tables each identifying for a port of a micro-controller, signals to be received or output via one or more pins associated with said port when a register associated with said port is set to a defined value;
a peripheral database configured to store data identifying for each of said plurality of peripherals, the signals required for routing to and from said selected peripherals to enable each of said peripherals to function; and
a configuration checking module operable to utilise said configuration tables and said peripheral database to identify combinations of register values which when stored within registers of a micro-controller enable all of signals required by an identified selection of peripherals to be routed via said ports of said micro-controller.

3. An apparatus in accordance with claim 1 wherein said determination module is operable to determine whether any combinations of register values which when stored within registers of a micro-controller enable all of signals required by an identified selection of peripherals to be routed via said ports of said micro-controller and to output warning data if no combination of register values enables all of the signals required by an identified selection of peripherals to be routed via said ports of said micro-controller.

4. An apparatus in accordance with claim 3 wherein said warning data comprises data identifying which peripherals of an identified selection of peripherals require incompatible register values to be stored within registers of a micro-controller to enable all of the signals required by said identified selection of peripherals to be routed via said ports of said micro-controller.

5. An apparatus in accordance with claim 3 wherein said warning data comprises data identifying an alternative micro-controller including said identified set of peripherals and which is capable of storing a set of register values which enable all of the signals required by said identified selection of peripherals to be routed via said ports of said alternative micro-controller.

6. An apparatus in accordance with claim 1 wherein said second user input interface is operable to generate a schematic representation of said micro-controller illustrating the relative physical locations of pins of the micro-controller utilised to route signals to and from an identified selection of peripherals when register values including register values corresponding to said combinations of register values are stored within the registers of said micro-controller.

7. An apparatus in accordance with claim 6 wherein said second user input interface is operable to order said plurality of combinations of register values and generate a said schematic representation on the basis of a user selection of a combination from said ordered selection of combinations.

8. An apparatus in accordance with claim 7 wherein said second user input interface is operable to order said plurality of combinations of register values on the basis of the number of said pins of said micro-controller dedicated to routing signals for general purpose inputs and outputs when said combinations of register values are stored within the registers of said micro-controller.

9. An apparatus in accordance with claim 7 wherein said second user input interface is operable to order said plurality of combinations of register values on the basis of the relative distances between representations of said selected peripherals within said display and said representations of pins associated with routing signals to said respective peripherals when said combinations of register values are stored within the registers of said micro-controller.

10. An apparatus in accordance with claim 1 wherein said micro-controller further comprises one or more registers operable to store settings data for said plurality of peripherals, said apparatus further comprising a third user input interface operable to enable a user to input data identifying register values for storage in said one or more registers associated with said selection of peripherals.

11. An apparatus in accordance with claim 1 wherein said output module is operable to output data identifying a set of register values comprising register values corresponding to a selected combination of register values and default values for registers for which no other register values are identified.

12. An apparatus in accordance with claim 1 wherein said output module is operable to generate a computer program operable when stored in a memory associated with a said micro-controller to cause said micro-controller to store register values corresponding to said identified set of register values in registers in said micro-controller.

13. An apparatus in accordance with claim 1 wherein said output module is operable to output data defining a schematic representation of a said micro-controller including labels identifying said set of signals required for routing to and from said selected peripherals to enable each of said peripherals to function.

14. An apparatus in accordance with claim 13 wherein said output module is operable to output data defining a schematic representation wherein said labels are grouped in said representation by the peripherals associated with said identified signals.

15. An apparatus in accordance with claim 13 wherein said output module is operable to output data defining a schematic representation wherein said labels are grouped in said representation so as to represent the physical locations of pins transferring said signals.

16. An apparatus in accordance with claim 1 wherein at least one of said ports of said micro-controller comprises a port operable to transfer a single signal selected on the basis of a stored register value in a register associated with said port.

17. An apparatus in accordance with claim 16 wherein each of said ports of said micro-controller comprises a port operable to transfer a single signal selected on the basis of a stored register value in a register associated with said port, said apparatus being operable to identify sets of register values which when stored in said registers enables the signals required for an identified selection of peripherals to function to be transferred via said ports.

18. A method of identifying a set of register values for storage within registers of a micro-controller which includes a plurality of peripherals, the micro-controller being operable to route different selections of signals to and from said peripherals via a set of ports on the basis of the register values stored in said registers, said method comprising:
receiving data identifying a selection of peripherals from the plurality of peripherals included in said micro-controller;
determining for received data identifying a selection of peripherals, a set of signals required for routing to and from said selected peripherals to enable each of said peripherals to function;
identifying a plurality of combinations of register values which when stored within registers of a micro-controller enable all of the determined signals to be routed via ports of said micro-controller;
receiving data identifying a selection of one of said plurality of identified combinations of register values; and
outputting data identifying a set of register values for storage within registers in a micro-controller including register values corresponding to a selected combination of register values.

19. A method in accordance with claim 18 further comprising:
storing a plurality of configuration tables each identifying for a port of a micro-controller, signals to be received or output via one or more pins associated with said port when a register associated with said port is set to a defined value;
storing a peripheral database configured to store data identifying for each of said plurality of peripherals, the signals required for routing to and from said selected peripherals to enable each of said peripherals to function; and
utilising said configuration tables and said peripheral database to identify combinations of register values which when stored within registers of a micro-controller enable all of signals required by an identified selection of peripherals to be routed via said ports of said micro-controller.

20. A method in accordance with claim 18 further comprising:
outputting data identifying which peripherals of an identified selection of peripherals require incompatible register values to be stored within registers of a micro-controller to enable all of the signals required by said identified selection of peripherals to be routed via said ports of said micro-controller if no compatible set of register values can be identified.

21. A method in accordance with claim 18 further comprising:
outputting data identifying an alternative micro-controller including said identified set of peripherals, which is capable of storing a set of register values which enable all of the signals required by said identified selection of peripherals to be routed via said ports of said alternative micro-controller if no compatible set of register values can be identified.

22. A method in accordance with claim 18 further comprising:
generating data defining a schematic representation of said micro-controller illustrating the relative physical locations of pins of the micro-controller utilised to route signals to and from an identified selection of peripherals when register values including register values corresponding to said combinations of register values are stored within the registers of said micro-controller.

23. A method in accordance with claim 22 further comprising ordering said identified of combinations of register values; and
generating said schematic representation on the basis of a received user input selection of a combination from said ordered selection of combinations.

24. A method in accordance with claim 23 wherein said ordering of said plurality of combinations of register values comprises ordering on the basis of the number of said pins of said micro-controller dedicated to routing signals for general purpose inputs and outputs when said combinations of register values are stored within the registers of said micro-controller.

25. A method in accordance with claim 23 wherein said ordering of said plurality of combinations of register values comprises ordering on the basis of the relative distances between representations of said selected peripherals within a representative of said micro-controller and representations of pins associated with routing signals to said respective peripherals when said combinations of register values are stored within the registers of said micro-controller.

26. A method in accordance with claim 18 wherein said micro-controller further comprises one or more registers operable to store settings data for said plurality of peripherals, said method further comprising receiving data identifying register values for storage in said one or more registers associated with said selection of peripherals.

27. A method in accordance with claim 18 comprising outputting data identifying a set of register values comprising register values corresponding to the selected combination of register values and default values for registers for which no other register values are identified.

28. A method in accordance with claim 18 further comprising generating a computer program operable when stored in a memory associated with a said micro-controller to cause said micro-controller to store register values corresponding to said identified set of register values in registers in said micro-controller.

29. A method in accordance with claim 18 further comprising outputting data defining a schematic representation of a said micro-controller including labels identifying said set of signals required for routing to and from said selected peripherals to enable each of said peripherals to function.

30. A method in accordance with claim 29 wherein said labels are grouped in said representation by the peripherals associated with said identified signals.

31. A method in accordance with claim 29 wherein said labels are grouped in said representation so as to represent the physical locations of pins transferring said signals.

32. A method in accordance with claim 18 wherein at least one of said ports of said micro-controller comprises a port operable to transfer a single signal selected on the basis of a stored register value in a register associated with said port.

33. A method in accordance with claim 32 wherein each of said ports of said micro-controller comprises a port operable to transfer a single signal selected on the basis of a stored register value in a register associated with said port, said method comprising identifying sets of register values which when stored in said registers enables the signals required for an identified selection of peripherals to function to be transferred via said ports.

34. A computer readable medium storing computer implementable instructions to cause a programmable computer to perform a method for identifying a set of register values for storage within registers of a micro-controller which includes a plurality of peripherals, the micro-controller being operable to route different selections of signals to and from said peripherals via a set of ports on the basis of the register values stored in said registers, the method comprising:
receiving data identifying a selection of peripherals from the plurality of peripherals included in said micro-controller;
determining for received data identifying a selection of peripherals, a set of signals required for routing to and from said selected peripherals to enable each of said peripherals to function;
identifying a plurality of combinations of register values which when stored within registers of a micro-controller enable all of the determined signals to be routed via ports of said micro-controller;
receiving data identifying a selection of one of said plurality of identified combinations of register values; and
outputting data identifying a set of register values for storage within registers in a micro-controller including register values corresponding to a selected combination of register values.

35. A computer readable medium in accordance with claim 34 wherein said method further comprises:
storing a plurality of configuration tables each identifying for a port of a micro-controller, signals to be received or output via one or more pins associated with said port when a register associated with said port is set to a defined value;
storing a peripheral database configured to store data identifying for each of said plurality of peripherals, the signals required for routing to and from said selected peripherals to enable each of said peripherals to function; and
utilising said configuration tables and said peripheral database to identify combinations of register values which when stored within registers of a micro-controller enable all of signals required by an identified selection of peripherals to be routed via said ports of said micro-controller.

36. A computer readable medium accordance with claim 34 wherein said method further comprises:
outputting data identifying which peripherals of an identified selection of peripherals require incompatible register values to be stored within registers of a micro-controller to enable all of the signals required by said identified selection of peripherals to be routed via said ports of said micro-controller if no compatible set of register values can be identified.

37. A computer readable medium in accordance with claim 34 wherein said method further comprises:
outputting data identifying an alternative micro-controller including said identified set of peripherals, which is capable of storing a set of register values which enable all of the signals required by said identified selection of peripherals to be routed via said ports of said alternative micro-controller if no compatible set of register values can be identified.

38. A computer readable medium in accordance with claim 34 further comprising:
generating data defining a schematic representation of said micro-controller illustrating the relative physical locations of pins of the micro-controller utilised to route signals to and from an identified selection of peripherals when register values including register values corresponding to said combinations of register values are stored within the registers of said micro-controller.

39. A computer readable medium in accordance with claim 38 further comprising:
ordering said identified of combinations of register values; and
generating said schematic representation on the basis of a received user input selection of a combination from said ordered selection of combinations.

40. A computer readable medium in accordance with claim 39 wherein said ordering of said plurality of combinations of register values comprises ordering on the basis of the number of said pins of said micro-controller dedicated to routing signals for general purpose inputs and outputs when said combinations of register values are stored within the registers of said micro-controller.

41. A computer readable medium in accordance with claim 39 wherein said ordering of said plurality of combinations of register values comprises ordering on the basis of the relative distances between representations of said selected peripherals within a representative of said micro-controller and representations of pins associated with routing signals to said respective peripherals when said combinations of register values are stored within the registers of said micro-controller.

42. A computer readable medium in accordance with claim 34 wherein said micro-controller further comprises one or more registers operable to store settings data for said plurality of peripherals, the method further comprising receiving data identifying register values for storage in said one or more registers associated with said selection of peripherals.

43. A computer readable medium in accordance with claim 34 wherein the method further comprises outputting data identifying a set of register values comprising register values corresponding to the selected combination of register values and default values for registers for which no other register values are identified.

44. A computer readable medium in accordance with claim 34 wherein the method further comprises generating a computer program operable when stored in a memory associated with a said micro-controller to cause said micro-controller to store register values corresponding to said identified set of register values in registers in said micro-controller.

45. A computer readable medium in accordance with claim 34 wherein the method further comprises outputting data defining a schematic representation of a said micro-controller including labels identifying said set of signals required for routing to and from said selected peripherals to enable each of said peripherals to function.

46. A computer readable medium in accordance with claim 45 wherein said labels are grouped in said representation by the peripherals associated with said identified signals.

47. A computer readable medium in accordance with claim 45 wherein said labels are grouped in said representation so as to represent the physical locations of pins transferring said signals.

48. A computer readable medium in accordance with claim 34 comprising a disk.

49. A disk in accordance with claim 48 comprising a magnetic, magneto-optic or optical disk.

50. A computer readable medium in accordance with claim 34 comprising an electrical signal within a computer network.

51. A method of programming a micro-controller including a plurality of peripherals, the micro-controller being operable to route different selections of signals to and from said peripherals via a set of ports on the basis of register values stored within registers within said micro-controller, the method comprising:
generating a computer program in accordance with the method of claim 28;
storing said generated computer program in a memory associated with a micro-controller; and
running said stored program to cause said micro-controller to store register values corresponding to said identified set of register values in said registers in said micro-controller.

52. A micro-controller comprising:
a plurality of peripherals;
a plurality of selectors, operable to route signals to and from peripherals via a set of ports on the basis of register values stored in registers associated with said ports;
a memory operable to store a configuration program; and
a processing unit operable to process a configuration program stored in said memory to store register values in said registers; wherein each of said ports of said micro-controller comprises a port operable to transfer a single signal selected on the basis of a stored register value in the register associated with said port.

53. An apparatus in accordance with claim 1, wherein said first user input interface is operable to enable a user to input data identifying a selection of external peripherals external to a micro-controller and to utilise said selection of external peripherals to identify a selection of peripherals from the plurality of peripherals included in said micro-controller required to interface with said selection of external peripherals.

54. An apparatus in accordance with claim 53, wherein said first user input interface is operable to determine whether the selection of peripherals necessary to interface with an input selection of external peripherals require one or more peripherals not included in a micro-controller wherein said output module is operable to output data to cause the generation of a computer program for causing the micro-controller to emulate one or more additional peripherals in addition to peripherals included in said micro-controller.

55. An apparatus in accordance with claim 53, wherein said one or more external peripherals include registers operable to store settings data, said apparatus further comprising a user input interface operable to enable a user to input data identifying register values for storage in said one or more registers associated with said selection of external peripherals.

56. An apparatus in accordance with claim 55, wherein said further user interface is operable to associate each selection of external peripherals with an internal peripheral and to cause the output module to output data identifying a set of register values for the external peripherals and associated internal peripherals which are compatible with one another.

57. A method in accordance with claim 18, wherein said receiving data identifying a selection of peripherals comprises data identifying one or more peripherals external to a micro-controller, said method further comprising processing said received data to identify a selection of peripherals from the plurality of peripherals included in said micro-controller required to interface with said external peripherals.

58. A method in accordance with claim 57, wherein if said determination of peripherals necessary to interface with external peripherals includes one or more peripherals not included in said micro-controller wherein said output step comprises outputting data to cause the generation of a computer program for causing the micro-controller to emulate one or more additional peripherals in addition to peripherals included in said micro-controller.

59. A method in accordance with claim 57, further receiving data identifying register values for storage in said one or more registers associated with said selection of external peripherals, wherein said output step includes identifying register values for storage within registers of one or more external peripherals corresponding to said received data.

60. An apparatus in accordance with claim 59, further comprising associating an external peripheral with an internal peripheral, wherein said output step comprises outputting data identifying a set of register values for the external peripherals and associated internal peripherals which are compatible with one another.

61. A computer readable medium in accordance with claim 34 wherein said receiving data identifying a selection of peripherals comprises data identifying one or more peripherals external to a micro-controller, said method further comprising processing said received data to identify a selection of peripherals from the plurality of peripherals included in said micro-controller required to interface with said external peripherals.

62. A computer readable medium in accordance with claim 61, wherein if said determination of peripherals necessary to interface with external peripherals includes one or more peripherals not included in said micro-controller wherein said output step comprises outputting data to cause the generation of a computer program for causing the micro-controller to emulate one or more additional peripherals in addition to peripherals included in said micro-controller.

63. A computer readable medium in accordance with claim 62, further receiving data identifying register values for storage in said one or more registers associated with said selection of external peripherals, wherein said output step includes identifying register values for storage within registers of one or more external peripherals corresponding to said received data.

64. A computer readable medium in accordance with claim 63, further comprising associating an external peripheral with an internal peripheral, wherein said output step comprises outputting data identifying a set of register values for the external peripherals and associated internal peripherals which are compatible with one another.
